(19) United States
(12) Patent Application Publication
(10) Pub. No.: US 2007/0022211 A1
(43) Pub. Date: Jan. 25, 2007

(54) Packet transfer system, communication network, and packet transfer method

(76) Inventors: Shinsuke Shimizu, Yokohama (JP); Hiroaki Miyata, Yokohama (JP); Migaku Ota, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/477,450

(22) Filed: Jun. 30, 2006

(30) Foreign Application Priority Data
Jul. 22, 2005 (JP) 2005-212938

(51) Int. Cl. G06F 15/173

(52) U.S. Cl. 709/238

(57) ABSTRACT

An IP address provision request issued from a client terminal according to the DHCP protocol is transferred to a DHCP server, and an application for provision of an IP address is received. At this time, a packet transfer system stores pieces of information on the client terminal (IP address and MAC address) in a memory unit. Moreover, the client terminal or the packet transfer system itself broadcasts an ARP request. Pieces of information on the client terminal (IP address and MAC address) contained in an ARP packet are also stored in the memory unit. If the stored IP addresses contained in the DHCP and ARP packets respectively agree with each other, packets addressed to the client terminal that has transmitted the ARP packet are filtered in order to decide whether the packets are allowed to pass through the port.

### BACKGROUND OF THE INVENTION

The present invention relates to a packet transfer system, a communication network, and a packet transfer method. More particularly, the present invention is concerned with a packet transfer system with address monitoring that connects a Dynamic Host Configuration Protocol (DHCP) server, which uses the DHCP to provide addresses, with a client terminal, a communication network, and a packet transfer method.

In the past, routers have been used to connect leased lines employed by businesses with wide area networks (WAN) including frame relay networks. However, local area networks (LAN) have come to support a high data transfer rate of 1 gigabit. Processing performed at the routers has become a bottleneck. A group of switches including a layer-3 switch and a layer-2 switch has taken over the routers to attract attention.

The router intended mainly for routing is a routing software product to be run on the UNIX. The routing is achieved by a general-purpose CPU and software. In contrast, the group of switches (hereinafter switches or switch) is intended for fast routing and designed to be implemented by an Application Specific Integrated Circuit (ASIC) that is dedicated hardware. Due to the mechanical difference, the employment of the switches would prove effective for the purpose of fast routing.

Under the foregoing circumstances, telecommunications carriers have evolved a wide-area switching service using switches in place of edge routers so as to cope with the trend toward diversity of access networks via which connection to the Internet is made, and fast and constant connection to the Internet. Moreover, when an application is installed in the switch, connection of each subscriber to an Internet Service Provider (ISP) can be facilitated. The application includes an application conformable to the Dynamic Host Configuration Protocol (DHCP).

The DHCP is a protocol for automatically assigning internet protocol (IP) addresses to clients. The DHCP is an expansion of the bootstrap protocol (Bootp) stipulated in the Request for Comment (RFC) 951. The DHCP defines a use-permitted period of time (lease period) during which an assigned IP address can be used and defines automatic designation of a set value such as an IP address provided by a Domain Name Server (DNS). The protocols are stipulated in, for example, the RFC 2131 and RFC 2132.

A DHCP server or a server adopting the DHCP dynamically assigns an IP address in response to a request issued from a client terminal. The client terminal can communicate data according to the Transmission Control Protocol/Internet Protocol (TCP/IP) suite without the necessity of designating an IP address. When the client terminal completes communication, the IP address is automatically collected and reassigned to other client terminal. Even users unfamiliar with a network configuration can readily access the Internet, and network managers can readily manage numerous client terminals on a centralized basis. Currently, the Internet and intranets are interconnected to become complex. Automatic provision of IP addresses by the DHCP server is quite helpful.

The DHCP server has the merit of dynamically assigning IP addresses. However, if a terminal user designates an IP address (hereinafter referred to as a static IP address) by himself/herself at his/her client terminal so as to access a network, the DHCP server cannot provide the IP address.

Since the DHCP server cannot manage such an IP address, an IP address that cannot be managed may be used to illegally access a network. For networks, security is one of very important issues. An illegal access prevention system technology has been disclosed (refer to, for example, Japanese Unexamined Patent Publication No. 2001-211180), wherein IP addresses and Media Access Control (MAC) addresses are stored in association with each other, client terminals identified with the addresses are regarded as authorized clients, and transfer of data to or from the other client terminals is disabled.

To be more specific, the DHCP server includes a storage database. In response to an IP address assignment request issued from a client terminal, the DHCP server collates the MAC address with a MAC address database, in which authorized client terminals are recorded, so as to check if the MAC address is recorded in the database. If the MAC address is recorded, an IP address associated with the MAC address is recorded in association with the MAC address in an assigned address database. Thereafter, a packet produced by the Address Resolution Protocol (ARP) is cyclically transmitted to the IP address, and a combination of a source MAC address and a source IP address contained in a response packet is collated with the assigned address database in order to check if the combination is recorded in the database. If the combination is recorded, the client is regarded as an authorized client. Otherwise, the client is regarded as an unauthorized client terminal.

As a technology of disabling communication by a terminal, which attempts to illegally access a network having simple architecture based on a switching hub, for example, Japanese Unexamined Patent Publication No. 2003-338826 has disclosed an art.

Specifically, the switching hub described in the Japanese Unexamined Patent Publication No. 2003-338826 treats a port of the switching hub, via which the DHCP server is connected, as a master port, and treats a physical port (hereinafter a port), via which a client terminal is connected, as a sub-port. In response to a signal sent from the DHCP server, a signal detection unit and a communication control unit control the master port and sub-port so as to disable connection of an illegal terminal.

However, according to the technology described in the Japanese Unexamined Patent Publication No. 2001-211180, the DHCP server must be a dedicated server. Moreover, the switching hub must have a feature that supports the dedicated server.

The art described in the Japanese Unexamined Patent Publication No. 2003-338826 does not merely disable communication of a terminal to which an IP address has already been assigned. The switching hub should include a port called a maser port via which the switching hub is connected to a network including the DHCP server, and a port via which the switching hub is connected to a client terminal. Unlike an ordinary switching hub, the switching hub does not permit free selection of a port via which equipment is connected.

Furthermore, the switching hub discontinues data transfer via a port, via which a client terminal is connected, according to the address of the client terminal. The art does not consider employment of the switching hub in a system in which switching hubs are cascaded via the port (connected in tandem) and a plurality of client terminals is connected subordinately to the switching hubs. Specifically, if any of the cascaded hubs accommodates an illegal client terminal, data transfer via the port via which the hub is connected is disabled. Consequently, the other authorized client terminals accommodated by the hub cannot communicate data any longer.

Accordingly, an object of the present invention is to provide a packet transfer system, a communication network, and a packet transfer method in which data transfer via each port is not discontinued (hereinafter interrupted) but in which when an accommodated client terminal is assigned a static IP address, data transfer is disabled. Another object of the present invention is to provide a technology for interrupting communication by filtering packets, which are addressed to a client terminal that is illegally accessing a network, on the basis of an IP address while employing a simple configuration. Another object of the present invention is to transfer information required for filtering to packet transfer systems that are cascaded.

### SUMMARY OF THE INVENTION

In order to solve the aforesaid problems, a packet transfer system with address monitoring includes a plurality of ports permitting accommodation of a plurality of client terminals or communication networks, a protocol handling unit, and a control unit.

The packet transfer system includes a means for, in response to a request for provision of an IP address by the DHCP which is issued from a client terminal, recording the MAC address of the client terminal in a user management table preserved in the packet transfer system with address monitoring. Moreover, the packet transfer system includes a means for, for example, after recording the MAC address, transferring information required by the terminal to DHCP servers included in a communication system, and for, after receiving an application for IP address assignment from each of the DHCP servers, instructing the protocol handling unit to record an IP address assigned to the terminal in the user management table. Furthermore, the packet transfer system includes a means for instructing the protocol handling unit to record the IP address of the terminal in the user management table by acquiring the IP address from an ARP packet returned in response to an ARP request broadcasted by the terminal or the packet transfer system with address monitoring. Moreover, the packet transfer system includes a means for, when recorded information contained in a DHCP packet and recorded information contained in the ARP packet agree with each other, filtering packets on the basis of the IP address so as to decide whether the packets are permitted to pass through a port via which the terminal that has transmitted the ARP packet is connected.

### BRIEF DESCRIPTION OF THE DRAWINGS

FIG. 1 shows a communication system and a basic embodiment of the present invention;

FIG. 2 shows the structure of a DHCP packet;

FIG. 3 shows the structure of a control communication packet;

FIG. 4 shows the configuration of an example of a packet transfer system with address monitoring;

FIG. 5 shows the configuration of a protocol handling unit included in the example of the packet transfer system with address monitoring;

FIG. 6 shows a format for a user management table preserved in the example of the packet transfer system with address monitoring;

FIG. 7 shows the sequence of actions to be performed in a packet transfer system with address monitoring in accordance with the first embodiment (part 1);

FIG. 8 shows the sequence of actions to be performed in the packet transfer system with address monitoring in accordance with the first embodiment (part 2);

FIG. 9 is a flowchart (part 1) describing actions to be performed by the protocol handling unit included in the packet transfer system with address monitoring in accordance with the embodiment;

FIG. 10 is a flowchart (part 2) describing actions to be performed by the protocol handling unit included in the packet transfer system with address monitoring in accordance with the embodiment;

FIG. 11 is a flowchart (part 3) describing actions to be performed by the protocol handling unit included in the packet transfer system with address monitoring in accordance with the embodiment;

FIG. 12 shows the states of the user management table preserved in the packet transfer system with address monitoring in accordance with the first embodiment (part 1);

FIG. 13 shows the states of the user management table preserved in the packet transfer system with address monitoring in accordance with the first embodiment (part 2);

FIG. 14 shows the sequence of actions to be performed in a packet transfer system with address monitoring in accordance with the second embodiment;

FIG. 15 shows the states of a user management table preserved in the packet transfer system with address monitoring in accordance with the second embodiment;

FIG. 16 shows the sequence of actions to be performed in a packet transfer system with address monitoring in accordance with the third embodiment (part 1);

FIG. 17 shows the sequence of actions to be performed in the packet transfer system with address monitoring in accordance with the third embodiment (part 2);

FIG. 18 shows the sequence of actions to be performed in the packet transfer system with address monitoring in accordance with the third embodiment (part 3);

FIG. 19 shows the sequence of actions to be performed in the packet transfer system with address monitoring in accordance with the third embodiment (part 4);

FIG. 20 shows a format for an ARP packet; and

FIG. 21 shows a packet format for an ARP request and a packet format for an ARP ACK signal.

### DESCRIPTION OF THE PREFERRED EMBODIMENTS

Referring to the drawings, embodiments of the present invention will be described below.

### 1. First Embodiment

(System Configuration)

To begin with, the first embodiment of the present invention will be described below.

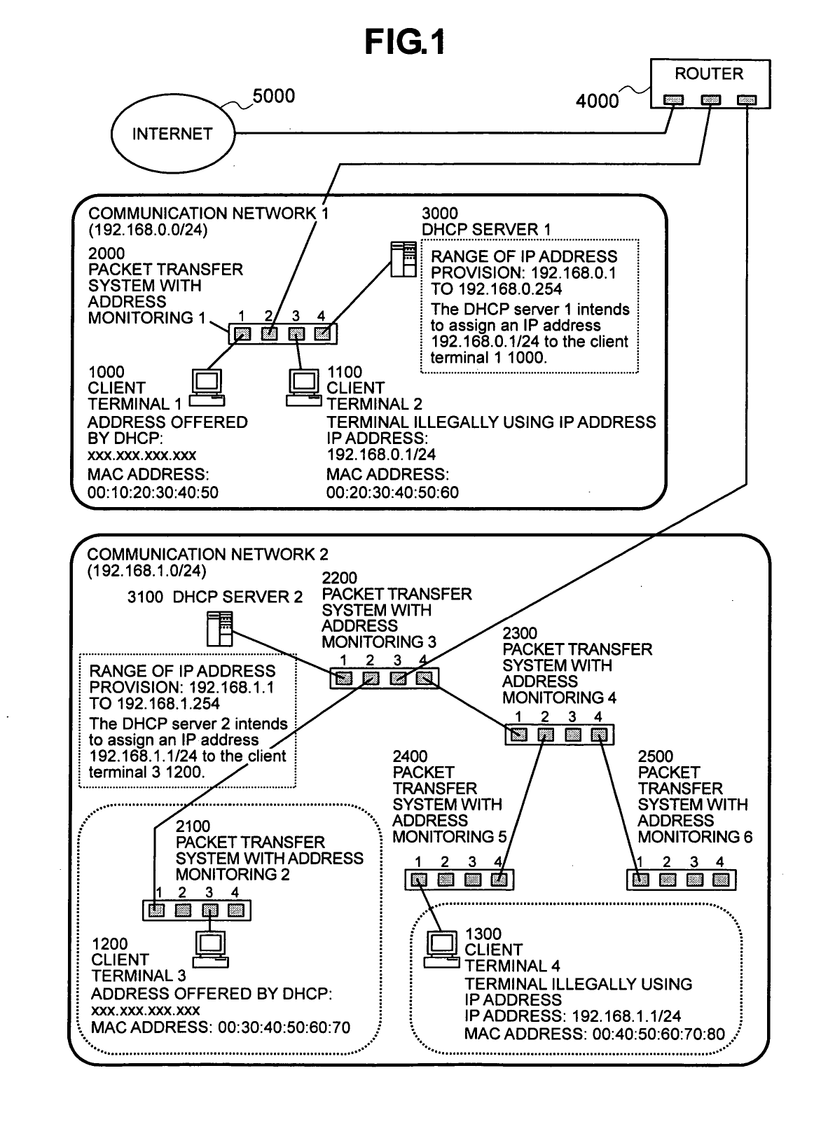

FIG. 1 shows an entire communication system in which a packet transfer system with address monitoring in accordance with an embodiment is employed.

The communication system includes a router 4000 connected to the Internet 5000, and communication networks 1 and 2 subordinate to the router 4000. The communication network 1 is an example of a network including one packet transfer system with address monitoring alone. The communication network 2 is an example of a network including a plurality of packet transfer systems with address monitoring. Incidentally, either of the communication networks 1 and 2 may be included or an appropriate number of communication networks 1 and an appropriate number of communication networks 2 may be included.

The communication network 1 includes a packet transfer system with address monitoring 1 (2000), a client terminal 1 (first terminal) (1000) and a client terminal 2 (second terminal) (1100) accommodated by the packet transfer system with address monitoring 1 (2000), and a DHCP server 1 (3000). The communication network 1 is, for example, a network identified with 192.168.0.0/24. The DHCP server 1 (3000) can provide IP addresses ranging from, for example, 192.168.0.1 to 192.168.0.254.

In the communication network 2, a packet transfer system with address monitoring 3 (2200) connected to the router 4000 accommodates a DHCP server 2 (3100), a packet transfer system with address monitoring 2 (2100), and a packet transfer system with address monitoring 4 (2300).

The packet transfer system with address monitoring 2 (2100) accommodates, for example, a client terminal 3 (third terminal) (1200). The packet transfer system with address monitoring 4 (2300) accommodates, for example, a packet transfer system with address monitoring 5 (2400) and a packet transfer system with address monitoring 6 (2500). Moreover, the packet transfer system with address monitoring 5 (2400) accommodates a client terminal 4 (fourth terminal) (1300) as a subordinate. The packet transfer systems may be connected to appropriate systems other than the foregoing ones.

The communication network 2 is, for example, a network identified with 192.168.1.0/24. The DHCP server 2 (3100) can assign IP addresses ranging from, for example, 192.168.1.1 to 192.168.1.254.

In the present embodiment, the client terminal is sensed when connected to a network, and physically connected to an Ethernet® network. Moreover, the router 4000 is thought to have a DHCP relay agent installed therein, and can relay a received broadcast packet. The router will not limit the present invention.

The components will be briefed below. Actions to be performed will be detailed later.

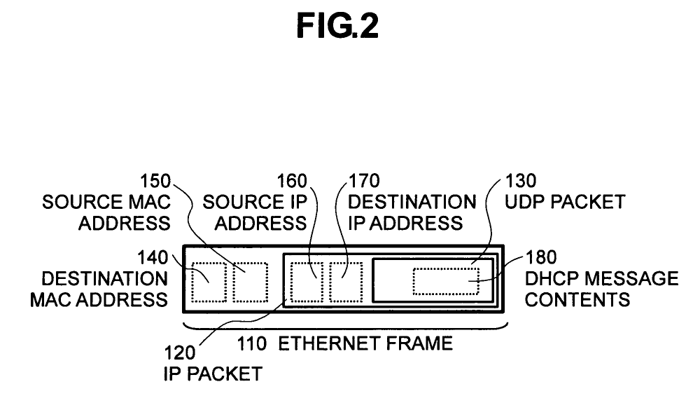

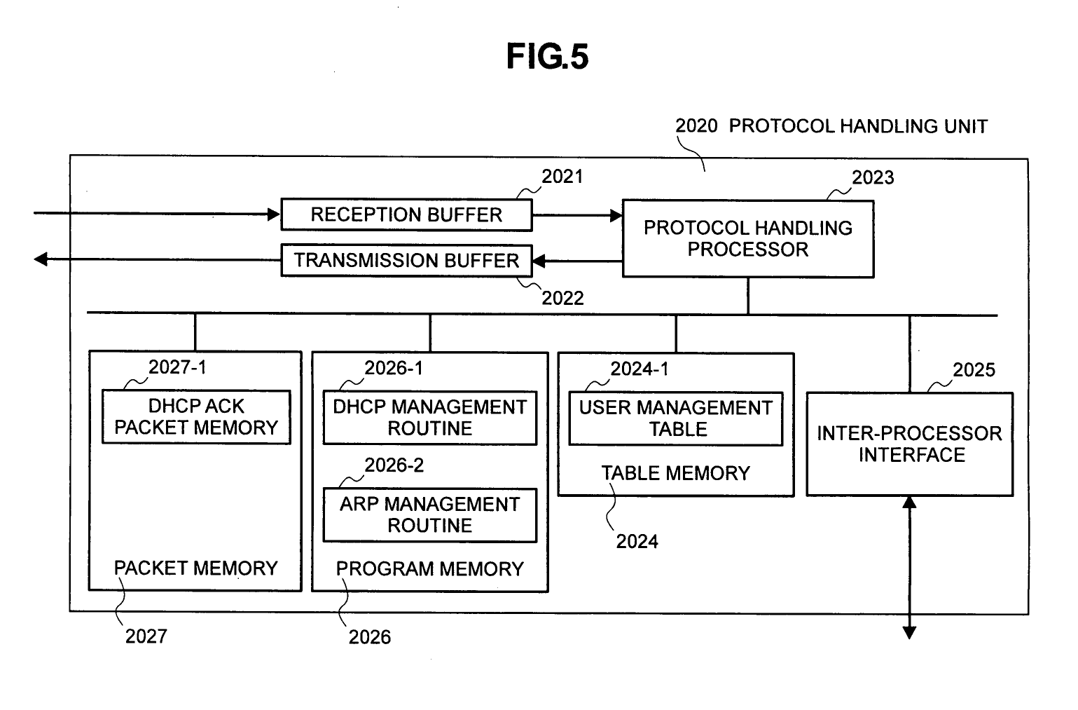

In the communication system to which the present embodiment is adapted, when a client terminal issues an IP address assignment request (IP address provision request), a DHCP packet shown in FIG. 2 is transferred to or from each DHCP server in an Ethernet frame format via a packet transfer system with address monitoring. When the DHCP packet passes through the packet transfer system with address monitoring, an IP address contained in the DHCP packet is recorded in a user management table that will be described later in conjunction with FIG. 5. Based on the records, the packet transfer system with address monitoring recognizes what IP address should be assigned to what client terminal.

After an IP address to be assigned by the DHCP server is determined, the packet transfer system with address monitoring provides the assigned IP address according to either of two address provision methods using the ARP.

One of the provision methods is such that the packet transfer system with address monitoring receives an acknowledge signal for IP address assignment from each DHCP server, and then transmits a DHCP packet to a client terminal. The client terminal having received the packet broadcasts an ARP request so as to check if the assigned IP address contained in the DHCP packet is duplicated. Eventually, the client terminal obtains the assigned IP address. The other method is such that, in response to an acknowledge signal for IP address assignment sent from each DHCP server, the packet transfer system with address monitoring broadcasts an ARP request to client terminals accommodated thereby. The present embodiment employs the former IP address provision method in which the client terminal broadcasts an ARP request. In relation to other embodiment, the latter method in which the packet transfer system with address monitoring broadcasts an ARP request to terminals accommodated thereby will be described.

Using either of the two ARP methods, if an ARP response is not returned (for example, the elapse of a time is indicated by a timer), a client terminal having broadcasted an ARP request can utilize an IP address assigned by a DHCP server. On the other hand, if the ARP response is returned, a packet transfer system with address monitoring that receives the ARP packet records an IP address and a MAC address contained in the ARP packet in the user management table. If the IP address contained in the DHCP packet and the IP address contained in the ARP packet agree with each other, packets bearing the MAC address of the terminal are filtered based on the IP address in order to decide whether the packets are permitted to pass through a port via which the ARP response is returned.

The packet transfer system with address monitoring does not transfer a broadcast ARP response. A control communication packet employed in the present embodiment permits transfer of pieces of information on a port that has packets, which bear an IP address, filtered, an MAC address, and the IP address to cascaded packet transfer systems with address monitoring. Consequently, communication is interrupted by filtering packets, which bear the MAC address of a client terminal using a static IP address, on the basis of the IP address. Thus, a technology of preventing illegal use of an IP address can be provided.

FIG. 2 shows a DHCP packet. As stipulated in the Request for Comments (RFC) 2131 and RFC 2132, the DHCP packet is transferred in an Ethernet frame format 110 and contains a destination MAC address 140, a source MAC address 150, and an IP packet 120. The IP packet 120 contains a destination IP address 160, a source IP address 170, and a User Data Protocol (UDP) packet 130. The UDP packet 130 contains DHCP message contents 180 signifying the contents of respective DHCP packets.

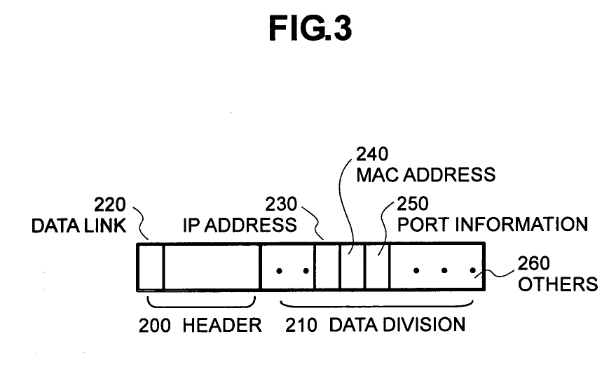

FIG. 3 shows a control communication packet. The control communication packet includes a header 200 and a data division 210. A data link subdivision 220 included in the header 200 contains the MAC addresses of the destination and source of the packet. The data division 210 contains an IP address 230 based on which packets should be filtered, a MAC address 240, and port information 250, and other information 260. A method of discriminating a control communication packet may be such that the data division and the other information 260 are used to monitor a flag. As the packet discrimination method, any appropriate method can be adopted. This example shall not limit the present invention.

The control communication packet is a packet helpful for other cascaded packet transfer systems with address monitoring. Even if a client terminal receives the control communication packet, the client terminal is not affected at all. When the packet transfer system with address monitoring receives the control communication packet, it can receive information on a port of a client terminal using a static IP address, and the MAC address and IP address thereof. Consequently, the packet transfer system with address monitoring filters packets, which are addressed to the client terminal using the static IP address, on the basis of the IP address, and interrupts communication so as not to allow the client terminal to transfer data.

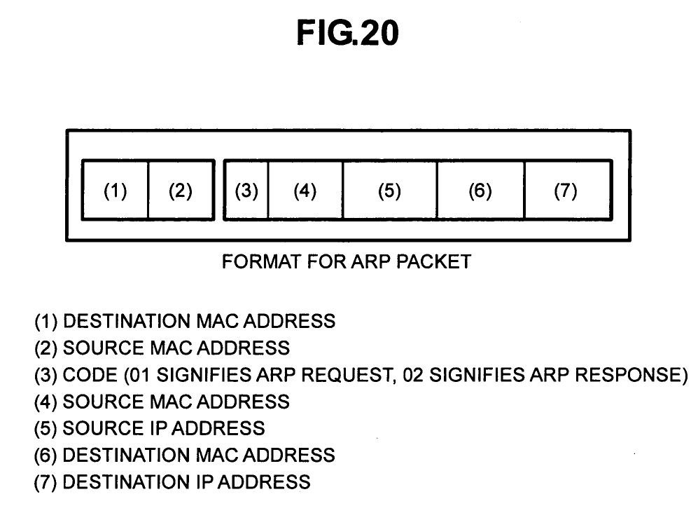

FIG. 20 shows a format for an ARP packet. The ARP packet contains, for example, (1) a destination MAC address, (2) a source MAC address, (3) a code (for example, 01 signifies an ARP request, and 02 signifies an ARP response), (4) a source MAC address, (5) a source IP address, (6) a destination MAC address, and (7) a destination IP address.

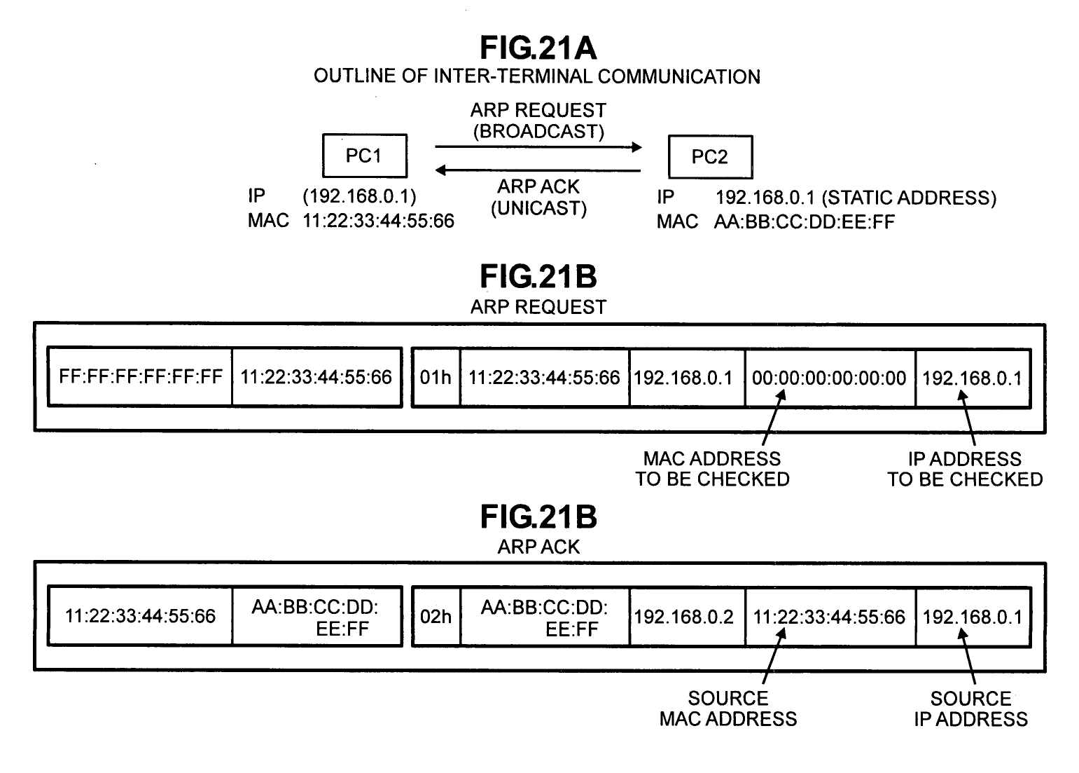

FIG. 21 shows a packet format for an ARP request and a packet format for an ARP acknowledge signal. In FIG. 21A, PC1 denotes a personal computer equivalent to, for example, the client terminal 1 (1000) shown in FIG. 1, and PC2 denotes a personal computer equivalent to the client terminal 2 (1100). For example, assume that addresses are, as shown in FIG. 21A, assigned to the personal computers, an ARP request sent from the personal computer PC1 (or a packet transfer system) is similar to the one shown in FIG. 21B. A destination MAC address FF:FF:FF:FF:FF:FF is a broadcast address. The ARP request contains an IP address to be checked (herein, 192.168.0.1 assigned to the personal computer PC1).

In response to the ARP request, the personal computer PC2 transmits an ARP acknowledge (ACK) signal like the one shown in FIG. 21C because the IP address to be checked agrees with the own IP address. The ARP ACK signal contains, for example, a destination MAC address and a source MAC address of the ARP request, and is transmitted through unicast.

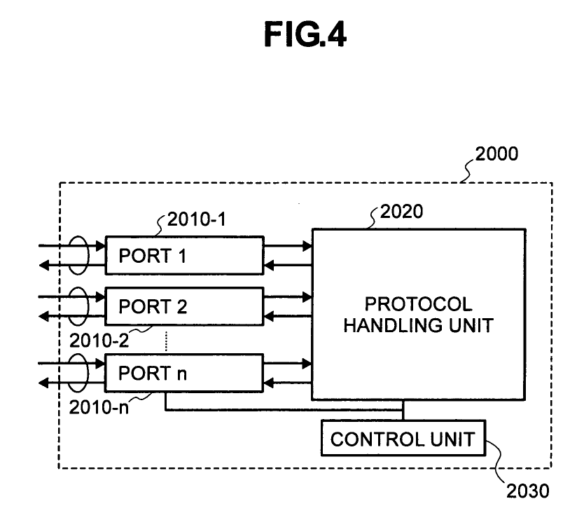

FIG. 4 is a block diagram showing the configuration of the packet transfer system with address monitoring 1 (2000) in accordance with the present embodiment. The other packet transfer systems with address monitoring 1 (2100 to 2500) have the same configuration. The packet transfer system with address monitoring 1 includes, for example, a plurality of input/output ports 2010-1 to 2010-n, a protocol handling unit 2020, and a control unit 2030 that controls the ports 2010.

The ports 2010 are interfaces for providing interface with client terminals and a communication network that accommodates packet transfer systems with address monitoring. Packets (for example, DHCP packets) are transferred to or from the plurality of client terminals and communication network via the ports. The protocol handling unit 2020 handles a protocol according to the contents of a packet received via the port 2010, and transmits data via any of the ports 2010-1 to 2010-n.

FIG. 5 is a block diagram showing the configuration of the protocol handling unit 2020 in detail. The protocol handling unit 2020 includes: a plurality of reception buffers 2021 in which a packet received via the port 2010 is temporarily stored; a protocol handling processor (processing block) 2023 that reads a packet from the reception buffer 2021 and handles a protocol; a program memory 2026 in which programs to be run by the processor 2023 (for example, a DHCP management routine 2026-1 and an ARP management routine 2026-2) are stored; a table memory 2024 in which a table (for example, a user management table 2024-1) is stored; a packet memory 2027 including a DHCP ACK packet memory 2027-1 in which a DHCP ACK signal packet is temporarily stored; transmission buffers 2022 in which a packet to be transmitted via the port 2010 is temporarily stored; and an inter-processor interface 2025 that is an interface for providing interface with the control unit 2030. As for the reception buffers and transmission buffers, pluralities of reception buffers and transmission buffers may be included. For example, the reception buffers and transmission buffers may be included in association with the ports.

The processor 2023 reads a packet stored in the reception buffer, handles a protocol using the DHCP management routine 2026-1, ARP management routine 2026-2, and user management table 2024-1, and transfers the packet to the transmission buffer 2022 according to the header of the packet.

The DHCP ACK packet memory 2027-1 that will be detailed laser is a memory in which a DHCP ACK signal to be transmitted to the packet transfer system with address monitoring 1 (2000) is temporarily stored.

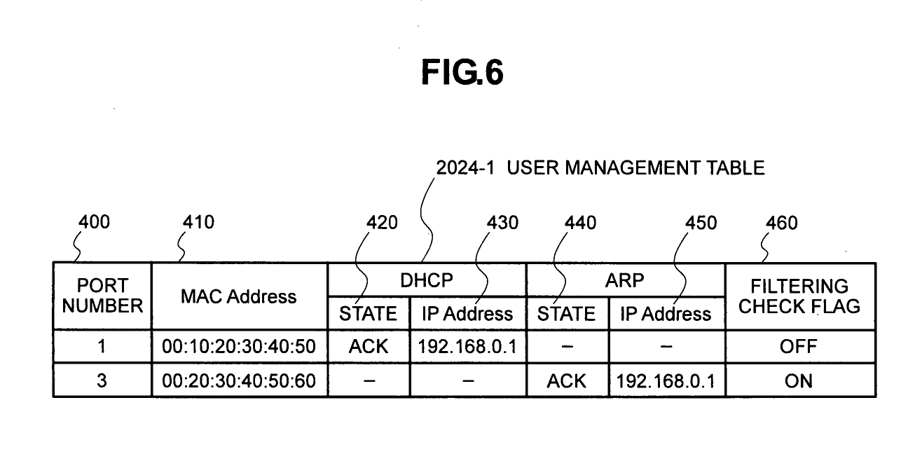

FIG. 6 shows the configuration of the user management table 2024-1.

In the user management table 2024-1, a port number (or identifier) 400 of a port included in the packet transfer system with address monitoring, a MAC address 410 of a client terminal connected via the port having the port number 400, the status (state) 420 of a DHCP packet, an IP address 430 to be assigned by a DHCP server, the status (state) 440 of an ARP packet, an IP address 450 to be mapped by the ARP, and On or Off (a filtering check flag) 460 signifying whether filtering is performed based on an IP address are recorded in association with one another.

Every time a DHCP packet or an ARP packet is received, the protocol type (status) of the packet is checked, and the state of the DHCP or ARP packet recorded in the user management table 2024-1 included in the packet transfer system with address monitoring is updated. Moreover, if the IP address 430 to be assigned by the DHCP server agrees with the IP address 450 to be mapped by the ARP, packets bearing the MAC address 410 of a terminal using the IP address 450 to be mapped by the ARP are filtered based on the IP address. Whether filtering is performed is signified with On or Off recorded in the filtering check column (flag).

(Sequence of Actions)

Now, actions to be performed in the present embodiment will be described below.

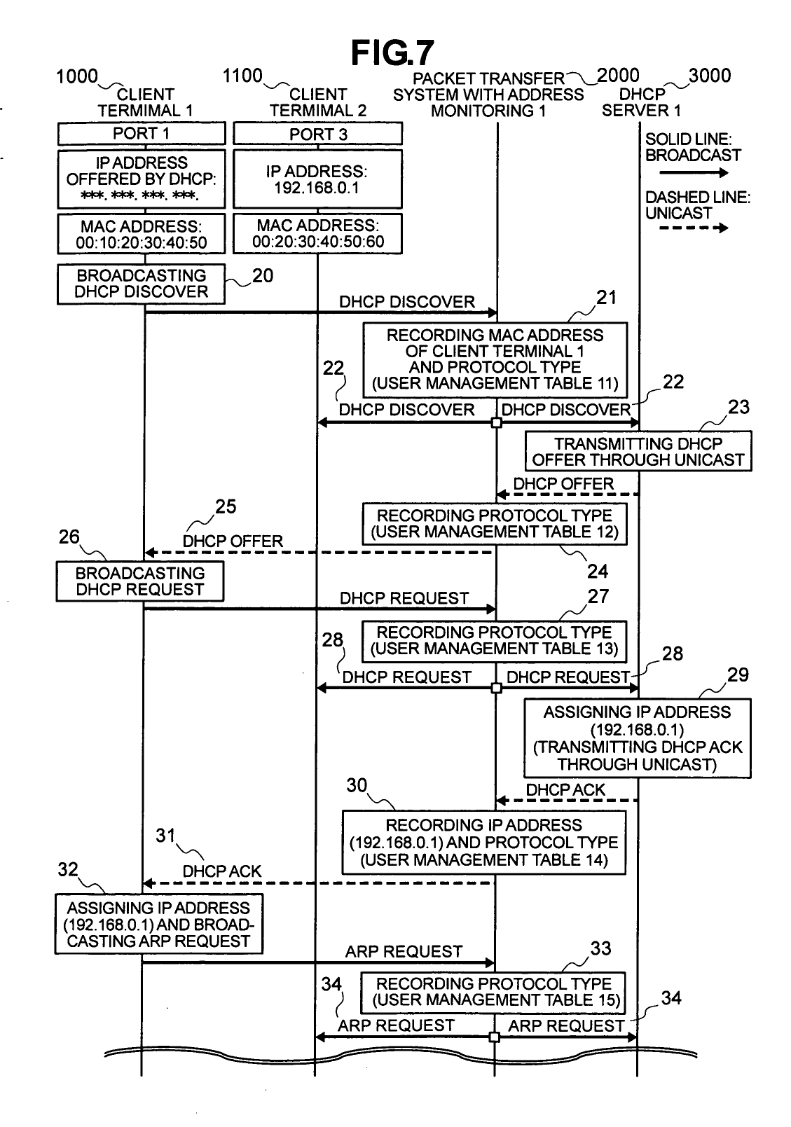

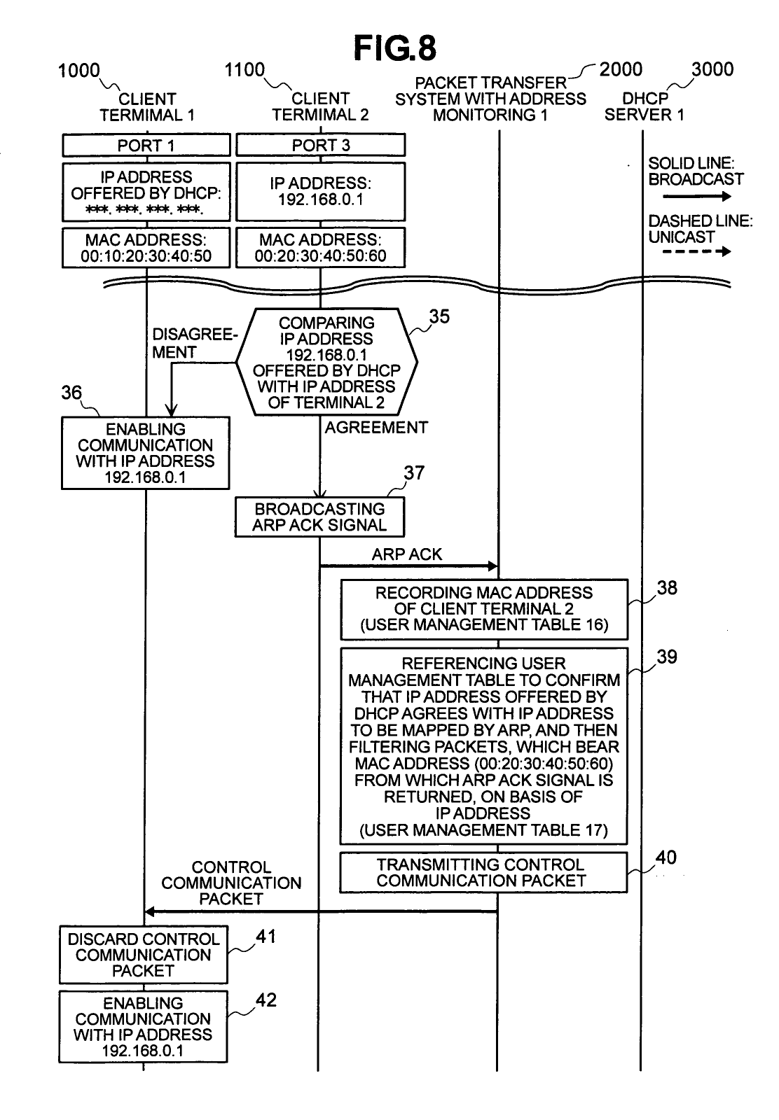

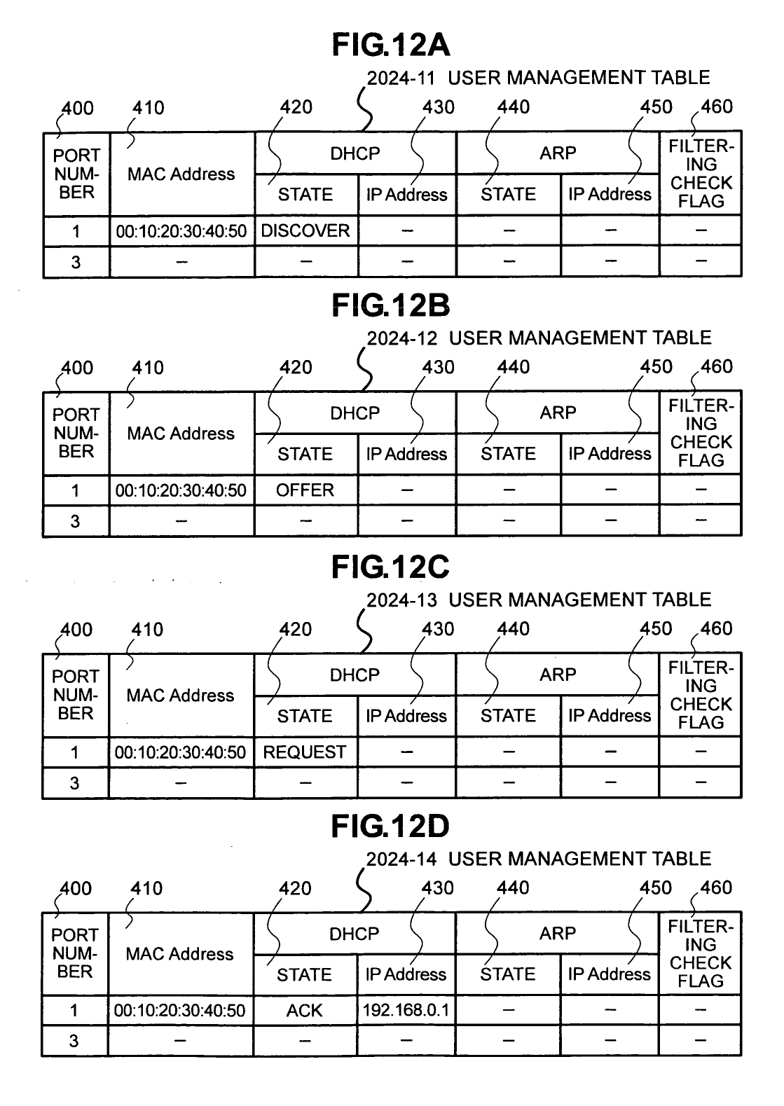

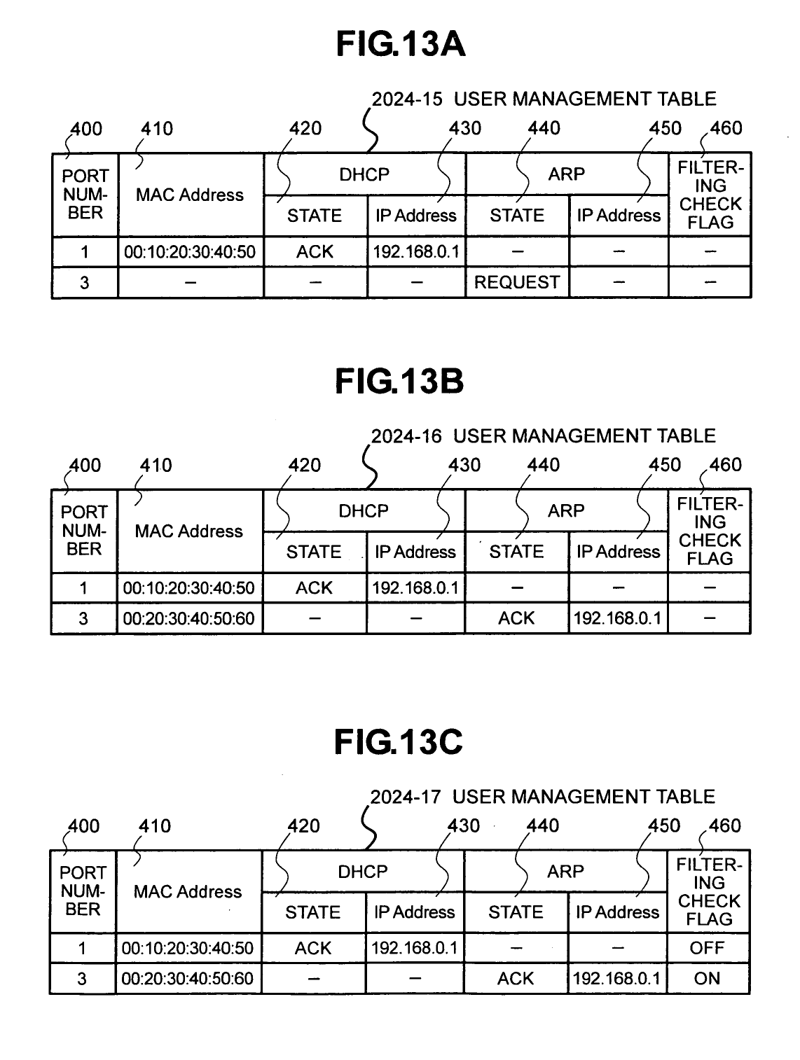

FIG. 7 and FIG. 8 show the sequence of actions to be performed in the communication network 1 in accordance with the first embodiment. FIG. 12 and FIG. 13 show the states of the user management table relevant to the actions performed in the present embodiment.

As shown in FIG. 1, in the communication network, the client terminal 1 (1000) is connected to the packet transfer system with address monitoring 1 (2000) via a port 1, the router 4000 is connected thereto via a port 2, the client terminal 2 (1100) is connected thereto via a port 3, and the DHCP server 1 (3000) is connected thereto via a port 4. Herein, the client terminal 1 (1000) is a terminal that hopes the DHCP server 1 (3000) will assign an IP address thereto and that is currently assigned a MAC address (00:10:20:30:40:50) alone. On the other hand, the client terminal 2 (1100) is a terminal already assigned a MAC address (00:20:30:40:50:60) and a static IP address (192.168.0.1) alike. In the present embodiment, the terminal thus assigned a static IP address is supposed to be a terminal illegally using an IP address.

In order to initiate a DHCP sequence, the client terminal 1 (1000) transmits a DHCP Discover packet (an address discover packet) to a broadcast address using a User Datagram Protocol (UDP) (step 20). For example, the DHCP Discover packet contains the MAC address of the client terminal 1 (1000). The DHCP Discover packet is a protocol packet requesting assignment of an IP address. The DHCP server can employ any protocol as a protocol for providing an IP address. The protocol shall not limit the present embodiment.

The packet transfer system with address monitoring 1 (2000) having received DHCP Discover transfers the DHCP Discover to the protocol handling unit 2020 via the reception port 2010-1 and reception buffer 2021 included therein. Moreover, the DHCP management routine 2026-1 is run in order to record the MAC address of the client terminal 1 and the protocol type of the packet (herein DHCP Discover), which are contained in the DHCP Discover packet, in the user management table 2024-1 (this results in a user management table 2024-11 shown in FIG. 12) (step 21).

The protocol handling unit 2020 transmits the DHCP Discover to the client terminal 2 (1100) and the DHCP server 1 (3000) via the transmission buffers 2022 and transmission ports 2010-3 via which the client terminal 2 (1100) and DHCP server 1 (3000) are connected (step 22).

The client terminal 2 (1100) ignores the DHCP Discover and returns no response. In response to the inquiry of the DHCP Discover, the DHCP server 1 (3000) transmits a DHCP offer packet (DHCP address offer packet), which signifies that an IP address (herein, for example, 192.168.0.1) is offered to the client terminal 1 (1000), to the packet transfer system with address monitoring 1 (2000) through unicast (step 23).

The packet transfer system with address monitoring 1 (2000) having received the DHCP offer transfers the DHCP offer to the protocol handling unit 2020 via the reception port 2010-1 and reception buffer 2021 which are included therein. Moreover, the packet transfer system with address monitoring 1 (2000) runs the DHCP management routine 2026-1 so as to record the protocol type (herein DHCP Offer) of the packet in the user management table 2024-1 (this results in a user management table 2024-12 shown in FIG. 12) (step 24). For example, the user management table is referenced based on the MAC address contained in the offer, and Offer is recorded as the state 420 of the DHCP packet in association with the MAC address 410.

The packet transfer system with address monitoring 1 (2000) transmits the DHCP offer to the client terminal 1 (1000) via the transmission buffer 2022 and transmission port 2010-1 (step 25).

In response to the DHCP offer, the client terminal 1 (1000) broadcasts a DHCP request (DHCP address request), which is an application for assignment of an offered IP address (192.168.0.1) (step 26).

The packet transfer system with address monitoring 1 (2000) having received the DHCP request transfers the DHCP request to the protocol handling unit 2020 via the reception port 2010-1 and reception buffer 2021 included therein. Moreover, the packet transfer system with address monitoring 1 (2000) runs the DHCP management routine 2026-1 so as to record the protocol type of the packet (herein DHCP Request) in the user management table 2024-1 (this results in a user management table 2024-13 shown in FIG. 12) (step 27).

The protocol handling unit 2020 transmits the DHCP request to the client terminal 2 (1100) and DHCP server 1 (3000) via the transmission buffers 2022 and transmission ports 2010-3 via which the client terminal 2 (1100) and DHCP server 1 (3000) respectively are connected (step 28).

The client terminal 2 (1100) ignores the DHCP request and returns no response. The DHCP server 1 (3000) transmits a DHCP ACK signal (DHCP address provision response), which signifies that IP address assignment is acknowledged (steps 23 and 24: IP address 192.168.0.1), to the packet transfer system 1 (2000) through unicast (step 29).

The packet transfer system with address monitoring 1 (2000) having received the DHCP ACK signal transfers the DHCP ACK signal to the protocol handling unit 2020 via the reception port 2010-1 and reception buffer 2021 included therein. Moreover, the packet transfer system with address monitoring 1 (2000) runs the DHCP management routine 2026-1 so as to record the protocol type of the packet (DHCP ACK) and the assigned IP address (192.168.0.1) in the user management table 2024-1 (this results in a user management table 2024-14 shown in FIG. 12) (step 30). The IP address may be an offered IP address contained in the DHCP offer or an IP address contained in the DHCP request. The addresses correspond to 192.168.0.1.

The packet transfer system with address monitoring 1 (2000) transmits the DHCP ACK signal to the client terminal 1 (1000) via the transmission buffer 2022 and transmission port 2010-1 (step 31).

The client terminal 1 (1000) broadcasts an ARP request, which is described in the RFC 826, so as to check if the IP address offered by the DHCP server 1 (3000) is duplicated by any other client terminal (step 32). The ARP is a protocol for managing the relationship between a MAC address and an IP address, and is included in the TCP/IP suite and used to map IP addresses into Ethernet MAC addresses. Herein, the ARP request contains the offered IP address 192.168.0.1.

The packet transfer system with address monitoring 1 (2000) having received the ARP request transfers the ARP request to the protocol handling unit 2020 via the reception port 2010-1 and reception buffer 2021 included therein, and runs the ARP management routine 2026-2 so as to record the protocol type of the packet (herein ARP Request) in the user management table 2024-1 (this results in a user management table 2024-15 shown in FIG. 13) (step 33).

The protocol handling unit 2020 transmits the ARP request to the client terminal 2 (1100) and DHCP server 1 (3000) via the transmission buffers 2022 and transmission ports 2010-4 via which the client terminal 2 (1100) and DHCP server 1 (3000) respectively are connected (step 34).

The DHCP server 1 (3000) ignores the ARP request and returns no response. The client terminal 2 (1100) compares the IP address (192.168.0.1) of the client terminal 2 (1100) with the IP address (192.168.0.1) contained in the ART request. If the addresses disagree with each other, it means that the IP address contained in the ART request is not duplicated. The client terminal 1 (1000) can use the IP address offered by the DHCP server 1 (3000) (step 36). Herein, the IP address (192.168.0.1) offered by the DHCP server 1 (3000) is supposed to be duplicated with the IP address (192.168.0.1) of the client terminal 2 (1100). The client terminal 2 (1100) broadcasts an ARP ACK signal (ARP response) to the other client terminals including the client terminal 1 (1000) that is the source of the ARP request (step 37).

Ordinary switches (layer-2 switch and layer-3 switch) including the conventional packet transfer system transmit an ARP ACK signal to other client terminals including the source client terminal 1 (1000) in response to a broadcast ARP ACK signal. The client terminal 1 (1000) having received the ARP ACK signal transmits a DHCP Release packet to the DHCP server 1 (3000) so as to request reassignment of an IP address because the IP address (192.168.0.1) is duplicated. As long as the client terminal 2 (1100) has a static IP address (192.168.0.1), the DHCP server 1 (3000) cannot assign the address 192.169.0.1. In contrast, the packet transfer system with address monitoring 1 (2000) in accordance with the present embodiment having received the broadcast ARP ACK signal does not broadcast the ARP ACK signal to other client terminals. Since the ARP ACK signal is not transmitted to the client terminal 1 (1000), DHCP Release that requests reassignment of an IP address and that is transmitted from the client terminal 1 is not executed.

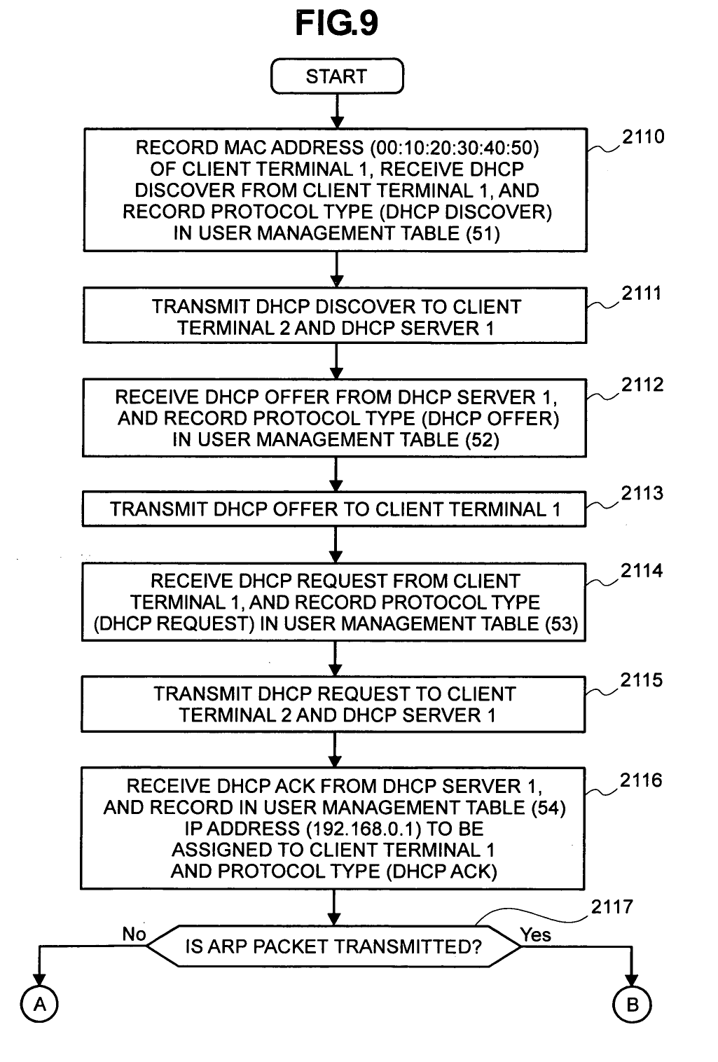

Moreover, the packet transfer system with address monitoring 1 (2000) transfers an ARP ACK signal to the protocol handling unit 2020 via the reception port 2010-3 and reception buffer 2021 included therein, and runs the ARP management routine 2026-2 to record the protocol type of the packet (herein ARP ACK) and an IP address (192.168.0.1) and a MAC address contained in the ARP ACK signal in the user management table 2024-1 (this results in a user management table 2024-16 shown in FIG. 9) (step 38). Herein, the pieces of information are recorded in association with the port 3 via which the ARP ACK signal is received.

Since the IP address (192.168.0.1) assigned by the DHCP server 1 (3000) agrees with the IP address (192.168.0.1) contained in the ARP ACK signal, the filtering check flag associated with the port 3 (via which the client terminal 2 is connected), via which the ARP ACK signal is received, in the user management table 2024-1 (user management table 2024-17 shown in FIG. 13) is set to On (step 29). Consequently, packets bearing the MAC address (00:20:30:40:50:60) and IP address (192.168.0.1) are filtered in order to decide whether the packets are permitted to pass through the port 3. In this state, the client terminal 2 (1100) illegally using an IP address cannot communicate data while using the IP address (192.168.0.1).

After receiving the ARP ACK signal, the packet transfer system with address monitoring 1 (2000) transmits a control communication packet (step 40). The control communication packet fills the role of transferring information on a port that has packets filtered, an IP address, and a MAC address to cascaded packet transfer systems with address monitoring or client terminals. Owing to the pieces of information, the cascaded packet transfer systems with address monitoring can obtain information on a client terminal whose packets should be filtered. Even when a client terminal receives the control communication packet, no problem will occur. When the client terminal 1 (1000) accommodated by the communication network 1 in accordance with the present embodiment receives the control communication packet, it discards the packet (step 41). Incidentally, steps 40 and 41 may be omitted from the present embodiment.

Consequently, the client terminal 2 (1100) cannot use the IP address (192.168.0.1). When the timer indicates the elapse of a predetermined time since transmission of an ARP request, the client terminal 1 (1000) can use the IP address (192.168.0.1) and communicate data (step 42).

(Flowchart)

FIG. 9 to FIG. 11 are flowcharts describing processing to be performed by the processor 2023 included in the protocol handling unit 2020 of the packet transfer system with address monitoring 1 (2000) in accordance with the present embodiment.

When the processor 2023 included in the packet transfer system with address monitoring 1 (2000) receives a broadcast DHCP Discover packet via the reception port 2010-1 (or reception port 2010-3) and the reception buffer 2021, the processor 2023 records the MAC address of the client terminal 1 (1000) and the protocol type of the DHCP packet in the user management table 2024-1 (step 2210 corresponding to step 21 in FIG. 7). The state of the user management table 2024-1 comes to the one presented as a user management table 2024-11 in FIG. 12. Specifically, in association with the port 1 via which the client terminal 1 is connected, the address 00:10:20:30:40:50 of the client terminal 1 (1000) is recorded as the MAC address 410 of the terminal, and DHCP Discover is recorded as the protocol type 420 of the DHCP packet.

The protocol handling unit 2020 transmits DHCP Discover to each of the client terminal 2 (1100) and DHCP server 1 (3000) via the transmission buffers 2022 and transmission ports 2010-3 via which the client terminal 2 (1100) and DHCP server 1 (3000) respectively are connected (step 2111 corresponding to step 22 in FIG. 7).

The client terminal 2 (1100) returns no response. A DHCP offer sent through unicast is received from the DHCP server 1 (3000) via the reception port 2010-4 and reception buffer 2021 included in the packet transfer system with address monitoring 1 (2000). In response to the DHCP ACK offer, the packet transfer system with address monitoring 1 (2000) records the protocol type of the DHCP packet (DHCP Offer) in association with the port 1 in the user management table 2024-1 included therein (step 2112 corresponding to step 24 in FIG. 7). The state of the user management table 2024-1 comes to the one presented as a user management table 2024-12 in FIG. 12. DHCP Offer is recorded as the protocol type 420 of the DHCP packet in association with the port 1.

The protocol handling unit 2020 transfers the DHCP offer to the client terminal 1 (1000) via the transmission buffer 2022 and transmission port 2010-1 via which the client terminal 1 (1000) is connected (step 2113 corresponding to step 25 in FIG. 7).

If the client terminal 1 (1000) responds to the DHCP offer, the packet transfer system with address monitoring 1 (2000) receives a broadcast DHCP request via the reception port 2010-1 and reception buffer 2021. The packet transfer system with address monitoring 1 (2000) having received the DHCP request records the protocol type of the DHCP packet in the user management table 2024-1 included therein (step 2214 corresponding to step 27 in FIG. 7). The state of the user management table 2024-1 comes to the one presented as a user management table 2024-13 in FIG. 12. DHCP Request is recorded as the protocol type 420 of the DHCP packet in response to the port 1 (step 2214 corresponding to step 27 in FIG. 7).

The protocol handling unit 2020 transmits the DHCP request to each of the client terminal 2 (1100) and DHCP server 1 (3000) via the transmission buffers 2022 and transmission ports 2010-3 via which the client terminal 2 (1100) and DHCP server 1 (3000) respectively are connected (step 2115 corresponding to step 28 in FIG. 7).

The client terminal 2 (1100) returns no response. A DHCP ACK signal that is transmitted through unicast is received from the DHCP server 1 (3000) via the reception port 2010-4 and reception buffer 2021 included in the packet transfer system with address monitoring 1 (2000). An IP address to be assigned to the client terminal 1 (1000) and the protocol type of the DHCP packet are recorded in the user management table 2024-1 included in the packet transfer system with address monitoring 1 (2000) (step 2116 corresponding to step 30 in FIG. 7). The IP address to be assigned may be the one contained in the DHCP ACK signal. The state of the user management table 2024-1 comes to the one presented as a user management table 2024-14 in FIG. 12. In association with the port 1, DHCP Request is recorded as the protocol type 420 of the DHCP packet and 192.168.0.1 is recorded as the IP address 430.

The packet transfer system with address monitoring 1 (2000) supports two ARP methods or modes. One of the ARP modes is a mode in which: the packet transfer system with address monitoring 1 (2000) having received a DHCP ACK signal from the DHCP server 1 (3000) transmits the DHCP ACK signal to the client terminal 1 (1000); and the client terminal 1 (1000) broadcasts an ARP request so as to check if an IP address (192.168.0.1), which is assigned based on the DHCP packet, is duplicated. In the other mode, when the packet transfer system with address monitoring 1 (2000) receives a DHCP ACK signal from the DHCP server 1 (3000), the packet transfer system with address monitoring 1 (2000) broadcasts an ARP request to the client terminal 1 (1000) and client terminal 2 (1100) accommodated thereby.

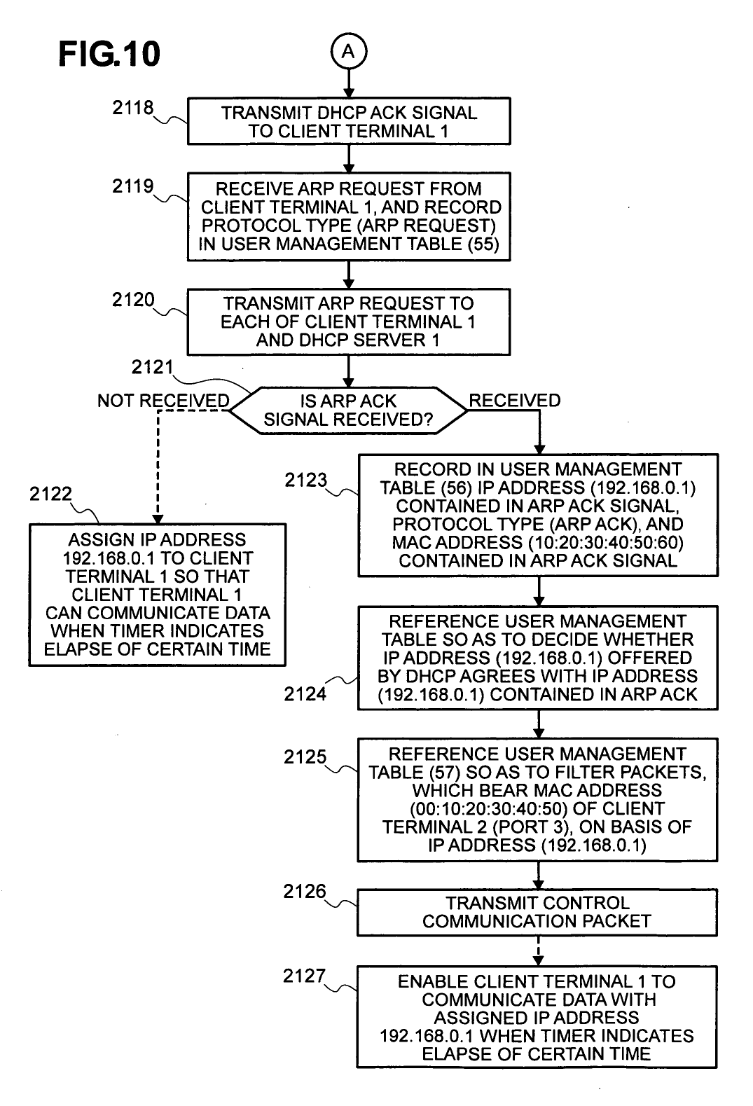

In the sequence described in FIG. 7, the former ARP method in which the client terminal 1 (1000) broadcasts an ARP request will be described. The latter method will be described later. Whichever of the two methods is adopted can be preset using, for example, a flag. The packet transfer system with address monitoring 1 (2000) may check the flag to make a decision on whether an ARP packet should be transmitted (step 2117). When the client terminal 1 (1000) broadcasts an ARP request (No at step 2117), after a DHCP ACK signal is stored, the protocol handling unit 2020 transmits the DHCP ACK signal to the client terminal 1 (1000) via the transmission buffer 2022 and transmission port 2010-1 via which the client terminal 1 (1000) is connected (step 2118 in FIG. 10 corresponding to step 31 in FIG. 7). The client terminal 1 (1000) having received the DHCP ACK signal broadcasts an ARP request.

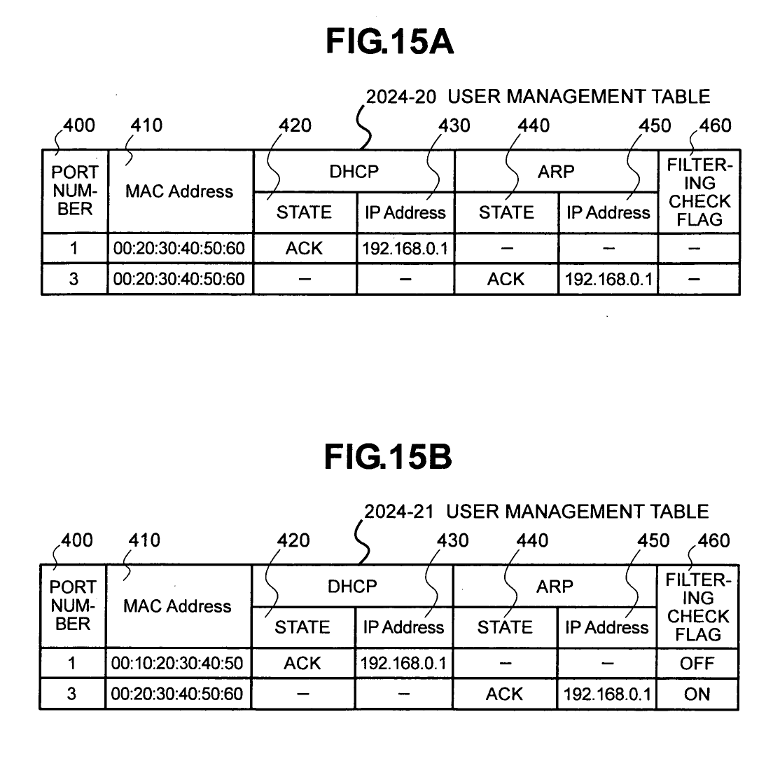

The packet transfer system with address monitoring 1 (2000) receives the ARP request via the reception port 2010-1 and reception buffer 2021. In response to the ARP request, the packet transfer system with address monitoring 1 (2000) records the protocol type of the ARP packet in the user management table 2024-1 included therein. The state of the user management table 2024-1 comes to the one presented as a user management table 2024-15 in FIG. 15. The ARP request is then transmitted. ARP Request is recorded as the protocol type 440 of the ARP packet in association with the port 3 (and port 4) (step 2119 corresponding to step 33 in FIG. 7).

After the ARP request is recorded, the protocol handling unit 2020 transmits the ARP request to the client terminal 2 (1100) and DHCP server 1 (3000) via the transmission buffers 2022 and transmission ports 2010-3 and 2010-4 via which the client terminal 2 (1100) and DHCP server 1 (3000) respectively are connected (step 2120 corresponding to step 34 in FIG. 7).

If the client terminal 2 (1100) uses the IP address (192.168.0.1), it means that the assigned IP address is duplicated. The packet transfer system with address monitoring 1 (2000) receives the ARP ACK signal from the client terminal 2 (1100) via the reception port 2010-3 and reception buffer 2021.

Supposing that the client terminal 2 (1100) has an address other than the IP address (192.168.0.1), the packet transfer system with address monitoring 1 (2000) receives no ARP ACK signal (step 2121). The client terminal 1 can use the assigned IP address (192.168.0.1) (step 2122).

Herein, the client terminal 2 (1100) is supposed to have the IP address (192.168.0.1), the ARP ACK signal is received through unicast. After receiving the ARP ACK signal (step 2121), the packet transfer system with address monitoring 1 (2000) records the protocol type of the ARP packet (ARP ACK) and the MAC address of the client terminal 2 (00:20:30:40:50:60) in the user management table 2024-1 included therein, and also records 192.168.0.1 as the IP address 430 therein. The state of the user management table 2024-1 comes to the one presented as a user management table 2024-16 in FIG. 13. In association with the port 3, 192.168.0.1 is recorded as the IP address 430 to be assigned to the client terminal 1 (1000), and ARP ACK is recorded as the protocol type 440 of the ARP packet (step 2123 corresponding to step 38 in FIG. 7).

In the user management table 2025-1 in which the above pieces of information have been recorded, the IP address (192.168.0.1) contained in the DHCP ACK signal and the IP address (192.168.0.1) contained in the ARP ACK signal agree with each other (step 2124).

When the IP addresses agree with each other, the state of the user management table 2024-1 comes to the one presented as a user management table 2024-17 in FIG. 13. When On is recorded as the filtering check flag 460, packets bearing the MAC address (00:20:30:40:50:60) and IP address (192.168.0.1) are filtered in order to decide whether the packets are permitted to pass through the port 3 (via which the client terminal 2 is connected) via which the ARP ACK signal is received (step 2125 corresponding to step 39 in FIG. 7). Consequently, the client terminal 2 (1100) illegally using the IP address cannot communicate data any longer.

When the ARP ACK signal is received, a control communication packet is used to automatically transmit the port number 3 of the port, via which the client terminal 2 (1100) whose IP address (192.168.0.1) is a duplicate is connected, the MAC address (00:20:30:40:50:60) thereof, and the IP address (192.168.0.1) thereof to the other packet transfer systems with address monitoring or client terminals (step 2126 corresponding to step 40 in FIG. 7).

Consequently, the client terminal 2 (1100) cannot use the IP address (192.168.0.1) any longer. When the timer indicates the elapse of a certain time, the client terminal 1 (1000) can use the assigned IP address (192.168.0.1) and communicate data.

### 2. Second Embodiment

Next, the second embodiment of the present invention will be described below. The configuration of a communication system and the configuration of a packet transfer system are identical to the aforesaid ones. An iterative description will be omitted.

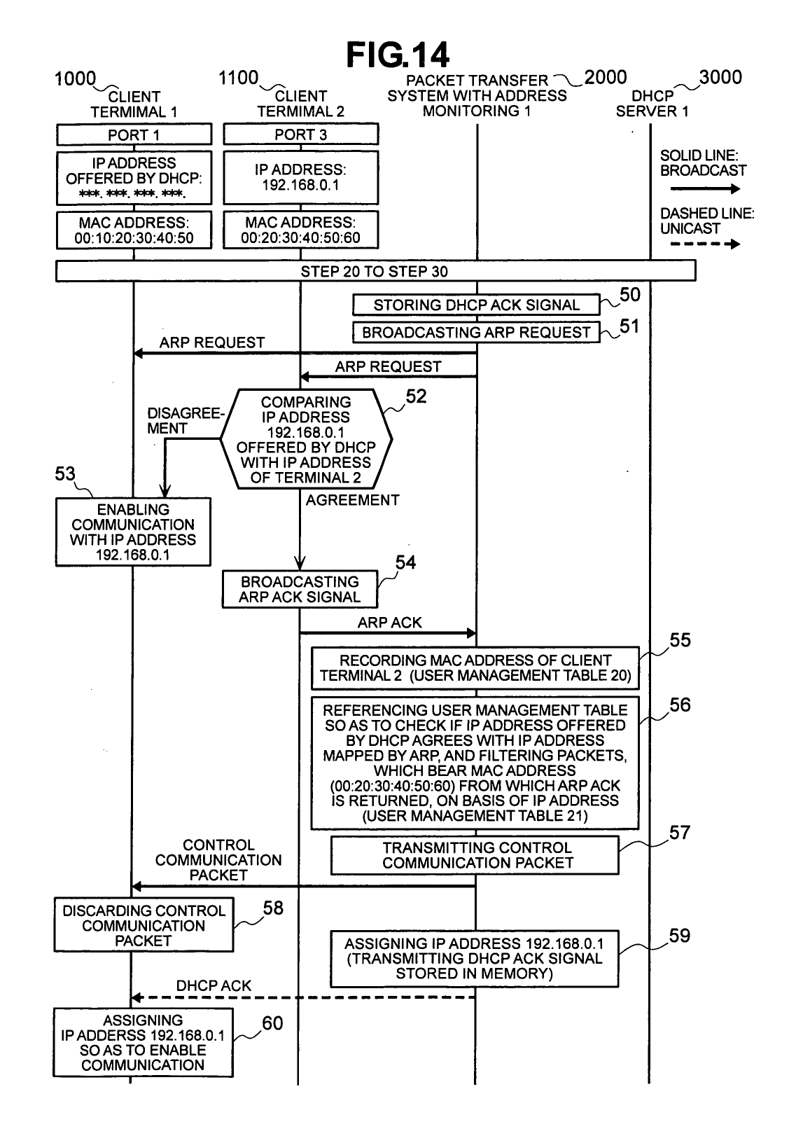

FIG. 14 shows a sequence of actions to be performed in the communication network 1 in accordance with the second embodiment. Steps 20 to 30 are identical to those included in the first embodiment and described in FIG. 7. An iterative description of the steps 20 to 30 will be omitted.

FIG. 15 shows the states of the user management table 2024-1 attained in the present embodiment. An iterative description of the states of the user management table 2024-1 attained at the steps 20 to 30 described in FIG. 7 (2024-11 to 2024-14 in FIG. 12) will be omitted.

The packet transfer system with address monitoring 1 (2000) receives a DHCP ACK signal (step 30), the DHCP ACK signal or message is stored in the DHCP ACK signal packet memory 2027-1 included therein (step 50).

The protocol handling unit 2020 included in the packet transfer system with address monitoring 1 (2000) transmits an ARP request to each of the client terminal 1 (1000) and client terminal 2 (1100) via the transmission buffers 2022 and transmission ports 2010-1 and 2010-3 via which the client terminal 1 (1000) and client terminal 2 (1100) respectively are connected (step 51). Herein, the ARP request contains an IP address (for example, 192.168.0.1) identical to the one contained in a DHCP ACK signal or a DHCP request.

The client terminal 1 (1100) does not respond to the ARP request. The client terminal 2 (1100) compares the IP address (192.168.0.1) thereof with the IP address (192.168.0.1) contained in the ARP request (step 52). If the IP addresses disagree with each other, the IP address is not duplicated. The client terminal 1 can therefore use the IP address offered by the DHCP server 1 (3000) (step 53). Herein, the IP address (192.168.0.1) offered by the DHCP server 1 (3000) is supposed to be duplicated with the IP address (192.168.0.1) of the client terminal 2 (1100). The client terminal 2 (1100) therefore broadcasts an ARP ACK signal (step 54). The ARP ACK signal is distributed to, for example, the packet transfer system 1 (2000) that is the source of the ARP request and other client terminals.

When the packet transfer system with address monitoring 1 (2000) receives the broadcast ARP ACK signal via the port 3, it does not broadcast the ARP ACK signal to the other client terminals connected thereto but transfers the ARP ACK signal to the protocol handling unit 2020 via the reception port 2010-3 and reception buffer 2021 included therein. The packet transfer system with address monitoring 1 (2000) runs the ARP management routine 2026-2 so as to record the protocol type of the packet (herein, ARP ACK), an IP address (192.168.0.1), and a MAC address (00:20:30:40:50:60) in association with the port 3 in the user management table 2024-1 (this results in a user management table 2025-20 shown in FIG. 15) (step 55).

Since the IP address (192.168.0.1) assigned by the DHCP server 1 (3000) agrees with the IP address contained in the ARP ACK signal (192.168.0.1), the user management table 2024-1 (user management table 2024-20 shown in FIG. 15) is referenced in order to filter packets bearing the MAC address (00:20:30:40:50:60) and IP address (192.168.0.1) so as to decide whether the packets are permitted to pass through the port 3 via which the ARP ACK signal is received (step 56). For example, On is recorded as the filtering check flag 460 in association with the port 3. In this state, the client terminal 2 (1100) illegally using the IP address cannot communicate data with the IP address (192.168.0.1) any longer.

On receipt of the ARP ACK signal, the packet transfer system with address monitoring 1 (2000) transmits a control communication packet (step 57). Even if a client terminal receives the control communication packet, no problem will occur. Even if the client terminal 1 (1000) accommodated by the communication network 1 receives the control communication packet, it will discard the packet (step 58). In the present embodiment, steps 57 and 58 may be omitted.

A DHCP ACK signal packet is read from the DHCP ACK signal packet memory 2027 included in the packet transfer system with address monitoring 1 (2000). The protocol handling unit 2020 transmits the DHCP ACK signal to the client terminal 1 (1000) via the transmission buffer 2022 and transmission port 2010-1 via which the client terminal 1 (1000) is connected (step 59).

The DHCP ACK signal is used to assign an IP address (192.168.0.1) to the client terminal 1 (1000).

Consequently, the client terminal 2 (1100) cannot use the IP address (192.168.0.1) any longer. When the timer indicates the elapse of a certain time, the client terminal 1 (1000) can use the IP address (192.168.0.1) and communicate data (step 60).

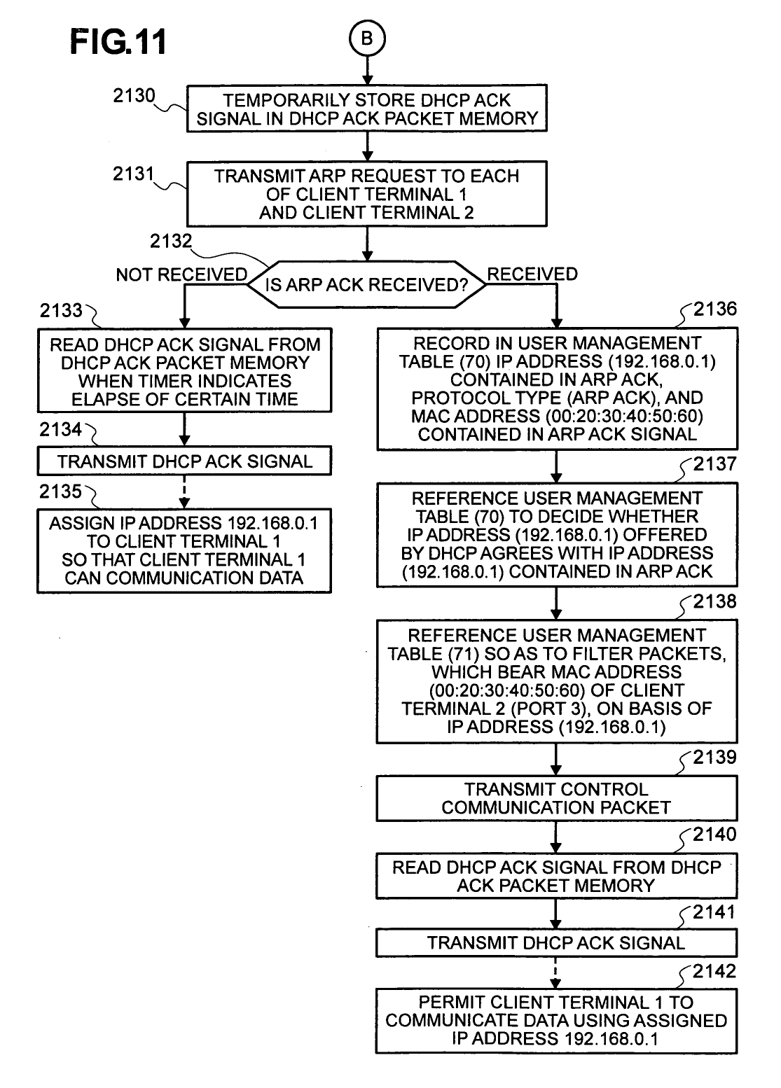

Next, referring to the flowcharts of FIG. 9 and FIG. 11, actions to be performed by the processor 2023 included in the protocol handling unit 2020 of the packet transfer system with address monitoring 1 (2000) in accordance with the second embodiment will be described below. Steps 2110 to 2117 are identical to those employed in the first embodiment. An iterative description will be omitted.

In the present embodiment, the packet transfer system with address monitoring 1 (2000) broadcasts an ARP request. At step 2117 in FIG. 9, a decision is made on whether an ARP packet should be transmitted, and control is passed to a flow B. When the packet transfer system with address monitoring 1 (2000) receives a DHCP ACK signal, it stores the DHCP ACK packet in the DHCP ACK packet memory 2027-1 included therein (step 2130 in FIG. 11 corresponding to step 50 in FIG. 14).

The protocol handling unit 2020 transmits an ARP request to each of the client terminal 1 (1000) and client terminal 2 (1100) via the transmission buffers 2022 and transmission ports 2010-1 via which the client terminal 1 (1000) and client terminal 2 (1100) respectively are connected (step 2131 corresponding to step 51 in FIG. 14).

Supposing the client terminal 2 (1100) has an address other than the IP address (192.168.0.1), the packet transfer system with address monitoring 1 (2000) does not receive an ARP ACK signal (step 2132). The protocol handling unit 2020 reads the DHCP ACK signal, which is temporarily stored, from the DHCP ACK packet memory 2027-1 (step 2133), and transmits the DHCP ACK signal to the client terminal 1 (1000) (step 2134). Consequently, the client terminal 1 can use the IP address (192.168.0.1) assigned using the DHCP ACK signal (step 2135).

Herein, the client terminal 2 (1100) is supposed to have the IP address (192.168.0.1). An ARP ACK signal is therefore received through unicast. Specifically, if the client terminal 2 (1100) uses the IP address (192.168.0.1), since the assigned IP address is duplicated, the packet transfer system with address monitoring 1 (2000) receives the ARP ACK signal from the client terminal 2 via the reception port 2010-3 and reception buffer 2021 (step 2132).

On receipt of the ARP ACK signal, the packet transfer system with address monitoring 1 (2000) records the protocol type of the ARP packet and the MAC address (00:20:30:40:50:60) of the client terminal 2, which is the source of the ARP ACK signal, in the user management table 2024-1 included therein. The state of the user management table 2024-1 comes to the one presented as a user management table 2024-20 in FIG. 15. In association with the port 3, 192.168.0.1 is recorded as the IP address 430 to be assigned to the client terminal 1 (1000), and ARP ACK is recorded as the protocol type 440 of the ARP packet (step 2136). The user management table 2024-1 demonstrates that the IP address (192.168.0.1) contained in the DHCP ACK signal agrees with the IP address (192.168.0.1) contained in the ARP ACK (step 2137).

The state of the user management table 2024-1 comes to the one presented as a user management table 2024-21 in FIG. 15. When On is recorded as the filtering check flag 460, packets bearing the MAC address (00:20:30:40:50:60) and IP address (192.168.0.1) are filtered in order to decide whether the packets are permitted to pass through the port 3 (via which the client terminal 2 is connected) via which the ARP ACK signal is received (step 2138). Consequently, the client terminal 2 (1100) illegally using the IP address cannot communicate data any longer.

When the ARP ACK signal is received, a control communication packet is used to automatically transmit the port number 3 of the port, via which the client terminal 2 (1100) whose IP address (192.18.0.1) is a duplicate is connected, and the MAC address (00:20:30:40:50:60) and IP address (192.168.0.1) of the client terminal 2 to the other packet transfer systems with address monitoring or other client terminals (step 2189). Moreover, the protocol handling unit 2020 reads the DHCP ACK signal, which is stored temporarily, from the DHCP ACK packet memory 2027-1 (step 2140), and transmits the DHCP ACK signal to the client terminal 1 (1000) (step 2141).

Consequently, the client terminal 2 (1100) cannot use the IP address (192.168.0.1) any longer, while the client terminal 1 (1000) can use the IP address (192.168.0.1) assigned using the DHCP ACK signal and communicate data.

### 3. Third Embodiment

In relation to the present embodiment, a description will be made of a network composed of a plurality of packet transfer systems with address monitoring similarly to the communication network 2 shown in FIG. 1. The configuration of a communication system and the configuration of the packet transfer system are identical to the aforesaid ones. An iterative description will be omitted. Incidentally, the communication network 1 may be excluded.

In the example shown in FIG. 1, the communication network 2 is an example of a network composed of five packet transfer systems with address monitoring. For example, the DHCP server 2 (3100) is connected to the packet transfer system with address monitoring 3 (second packet transfer system) (2200) via the port 1. The packet transfer system with address monitoring 2 (first packet transfer system) (2100) is connected thereto via the port 2. The router 4000 is connected thereto via the port 3, and the packet transfer system with address monitoring 4 (2300) is connected thereto via the port 4. Moreover, the packet transfer system with address monitoring 3 (2200) is connected to the packet transfer system with address monitoring 2 (2100) via the port 1, and the client terminal 3 (first terminal) (1200) is connected thereto via the port 3. The packet transfer system with address monitoring 3 (2200) is connected to the packet transfer system with address monitoring 4 (2300) via the port 1, the packet transfer system with address monitoring 5 (2400) is connected thereto via the port 2, and the packet transfer system with address monitoring 6 (2500) is connected thereto via the port 4. The client terminal 4 (second terminal) (1300) is connected to the packet transfer system with address monitoring 5 (2400) via the port 1. The packet transfer system with address monitoring 4 (2400) is connected to the packet transfer system with address monitoring 6 (2500) via the port 1. Incidentally, the systems and terminals can be connected via any appropriate ports. The packet transfer systems 4 to 6 may be excluded, and the client terminal 4 (1300) may be connected to the packet transfer system 3 (2200) via the port 4.

The client terminal 3 (1200) is a terminal that hopes the DHCP server 2 (3100) will assign an IP address, and that is currently assigned a MAC address (00:30:40:50:60:70) alone. On the other hand, the client terminal 4 (1300) is a client terminal assigned a MAC address (00:40:50:60:70:80) and a static IP address (192.168.1.1) alike, and supposed to a terminal illegally using an IP address.

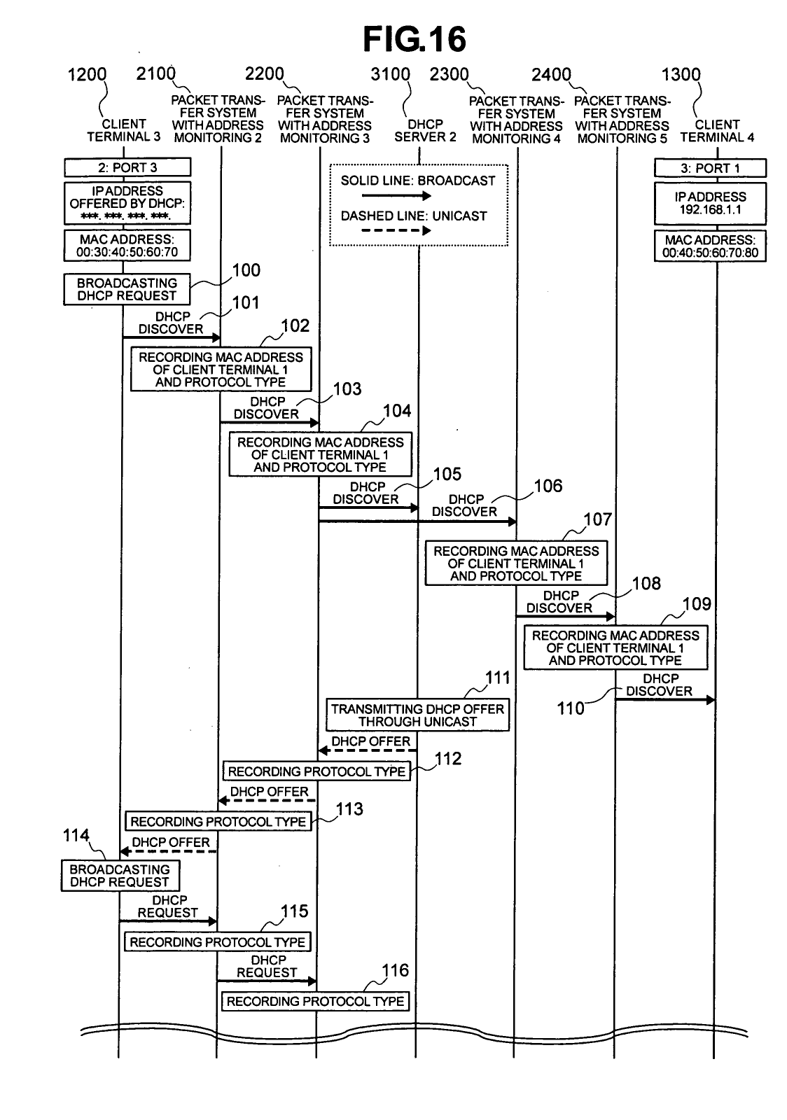

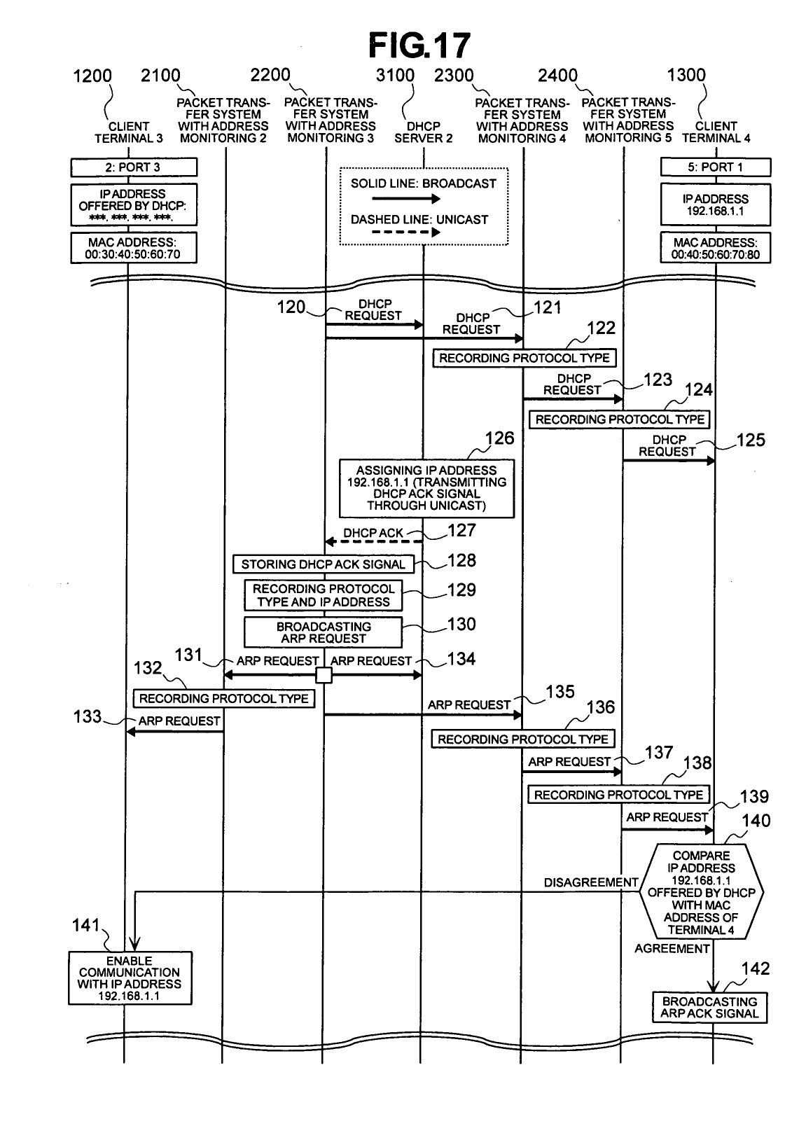

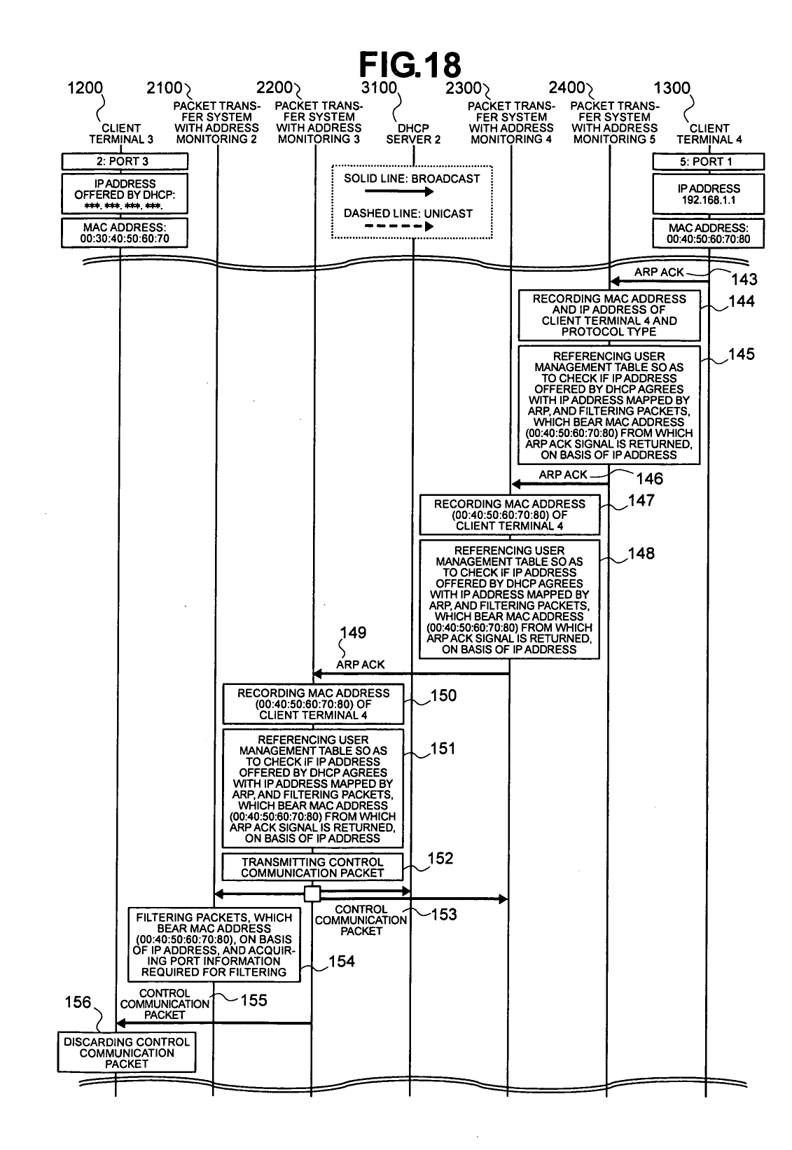

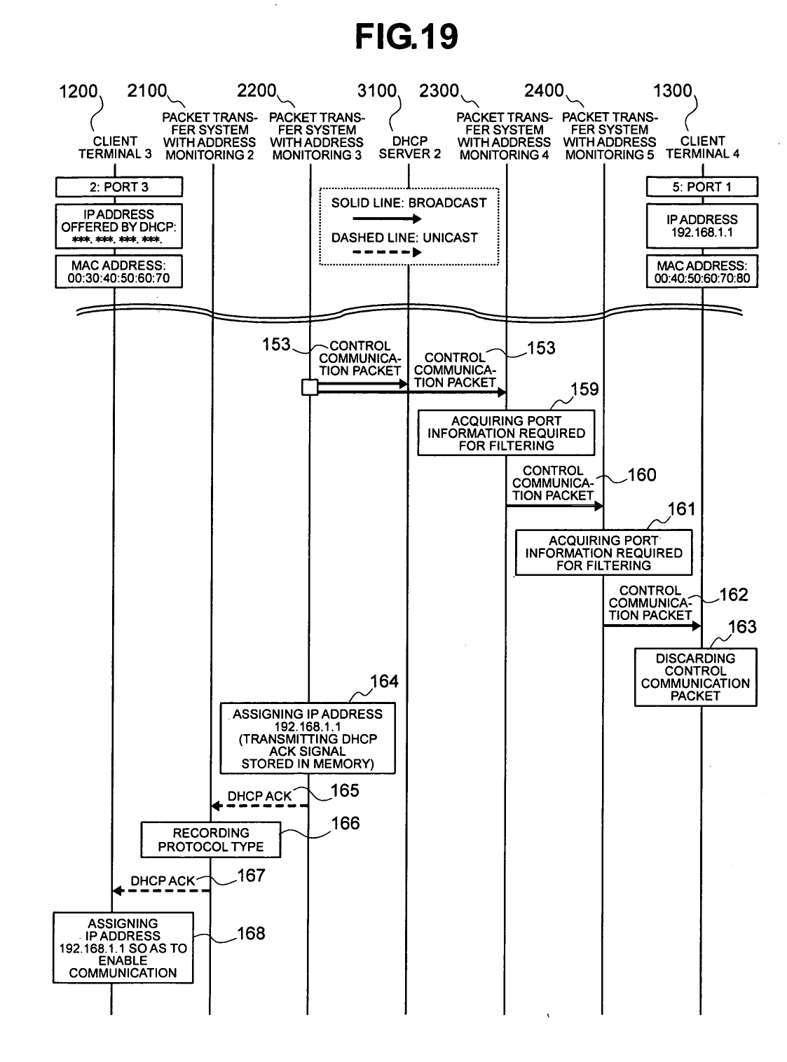

FIG. 16 to FIG. 19 show a sequence employed in the third embodiment. Actions to be performed by the processor 2023 included in the protocol handling unit 2020 of the present embodiment and the states of the user management table 2024-1 are identical to those in an individual packet transfer system with address monitoring, that is, identical to those in the first and second embodiments. An iterative description will be omitted.

The client terminal 3 (1200) broadcasts DHCP Discover, which requests assignment of an IP address, to the DHCP server 2 (3100) (step 100 and step 101). The packet transfer system with address monitoring 2 (2100) having received the DHCP Discover transfers the DHCP Discover to the protocol handling unit 2020 via the reception port 2010-3 and reception buffer 2021 included therein. Moreover, the packet transfer system with address monitoring 2 (2100) runs the DHCP management routine 2026-1 so as to record the protocol type of the packet (herein DHCP Discover) and the MAC address (00:30:40:50:60:70) of the client terminal 3 (1200) in the user management table 2024-1 (step 102).

The protocol handling unit 2020 transmits DHCP Discover to the packet transfer system with address monitoring 3 (2200) via the transfer buffer 2022 and transmission port 2010-1 via which the packet transfer system with address monitoring 3 (2200) is connected (step 103).

The packet transfer systems with address monitoring 2 (2100) to 5 (2400) perform the same actions (steps 102 to 110) as those of steps 101 to 103. An iterative description will be omitted.

At step 111, the DHCP server 2 (3100) transmits a DHCP offer to the client terminal 3 (1200) through unicast in response to the inquiry of DHCP Discover (105) (step 111). The packet transfer system with address monitoring 3 (2200) transmits the DHCP offer to the packet transfer system with address monitoring 2 (2100), and transfers the DHCP offer to the protocol handling unit 2020 via the reception port 2010-1 and reception buffer 2021 included therein. The packet transfer system with address monitoring 3 (2200) runs the DHCP management routine 2026-1 so as to record the protocol type of the packet (DHCP Offer) in the user management table 2024-1 (step 112). The packet transfer system with address monitoring 2 (2100) performs the same action (step 113) as the packet transfer system with address monitoring 3 does. An iterative description will be omitted.

Thereafter, the client terminal 3 (1200) having received the DHCP offer broadcasts a DHCP request in response to the DHCP offer (step 114). The packet transfer system with address monitoring 2 (2100) having received the DHCP request transfers the DHCP request to the protocol handling unit 2020 via the reception port 2010-3 and reception buffer 2021 included therein. Moreover, the packet transfer system with address monitoring 2 (2100) runs the DHCP management routine 2026-1 so as to record the protocol type of the packet (herein DHCP Request) in the user management table 2024-1. Moreover, the protocol handling unit 2020 transmits the DHCP request to the packet transfer system with address monitoring 3 (2200) via the transmission buffer 2022 and transmission port 2010-1 via which the packet transfer system with address monitoring 3 (2200) is connected (step 116).

The packet transfer systems with address monitoring 2 (2100) to 5 (2400) perform the same processing (steps 116 to 125) as that of step 115. An iterative description will be omitted.

At step 126, the DHCP server 2 (3100) transmits a DHCP ACK signal to the client terminal 3 (1200) through unicast in response to the inquiry of the DHCP request (step 120) (step 126 and step 127). The packet transfer system with address monitoring 3 (2200) having received the DHCP ACK signal temporarily stores the DHCP ACK packet in the DHCP ACK packet memory 2027-1 (step 128). The packet transfer system with address monitoring 3 (2200) transfers the DHCP ACK signal to the protocol handling unit 2020 via the reception port 2010-1 and reception buffer 2021 included therein. Moreover, the packet transfer system with address monitoring 3 (2200) runs the DHCP management routine 2026-1 so as to record the protocol type of the packet (herein DHCP ACK) and the assigned IP address (192.168.1.1) in the user management table 2024-1 (step 129).

The packet transfer system with address monitoring 3 (2200) transmits an ARP request to the subordinate packet transfer systems with address monitoring 2 (2100) to 6 (2500) and the client terminals 3 (1200) and 4 (1300) via the transmission buffers 2022 and the transmission ports 2010-2 and transmission ports 2010-3 (step 130). Each of the packet transfer systems with address monitoring receives the ARP request and records the protocol type of the DHCP packet (ART Request) in the user management table 2024-1 (step 131 to step 139). Moreover, each of the packet transfer systems broadcasts the ART request.

At step 140, the client terminal 4 (1300) receives the ARP request, and then compares the IP address (192.168.1.1) thereof with the IP address (192.168.1.1) contained in the ARP request packet (step 140). If the IP addresses disagree with each other, the IP address contained in the ARP request is not duplicated. This means that the IP address offered by the DHCP server 2 (3100) can be used (step 141). Herein, the IP address (192.168.1.1) offered by the DHCP server 2 (3100) is supposed to be duplicated with the IP address (192.168.1.1) of the client terminal 4 (1300). Therefore, the client terminal 4 (1300) broadcasts an ARP ACK signal to the other client terminals (steps 142 and 143).

On receipt of the broadcast ARP ACK signal, the packet transfer system with address monitoring 5 (2400) transfers the ARP ACK signal to the protocol handling unit 2020 via the reception port 2010-3 and reception buffer 2021 included therein. Moreover, the packet transfer system with address monitoring 5 (2400) runs the ARP management routine 2026-2 so as to record the protocol type of the packet (herein ARP ACK) and the IP address (192.168.1.1) and MAC address (00:40:50:60:70:80) of the client terminal 4 in the user management table 2024-1 (step 144).

Since the IP address assigned by the DHCP server 2 (3100) and the IP address contained in the ARP ACK signal (192.168.1.1) agree with each other, the user management table 2024-1 is referenced in order to filter packets, which bear the MAC address (00:40:50:60:70:80) and IP address (192.168.1.1), so as to decide whether the packets are permitted to pass through the port 1 (via which the client terminal 4 is connected) via which the ARP ACK signal is received. For example, when On is recorded as the filtering check flag in association with the port 1 in the user management table 2024-1, the filtering is performed. Moreover, the ARP ACK signal is broadcasted.

The packet transfer systems with address monitoring 4 (2300) to 3 (2200) perform the same processing (step 146 to step 151). An iterative description will be omitted.

The packet transfer system with address monitoring 3 (2200) having received the ARP ACK signal perform the same processing (step 150 and step 151) as the packet transfer systems with address monitoring 5 (2400) and 4 (2300) do. Moreover, the packet transfer system with address monitoring 3 (2200) transmits a control communication packet to the subordinate packet transfer systems with address monitoring but does not broadcast an ARP response (step 152 and step 153). The control communication packet contains, for example, the pieces of information shown in FIG. 3. Herein, as the pieces of information, that is, the IP address 230, MAC address 240, and port information 250, the pieces of information recorded in association with an entry having the filtering check flag set to On (herein pieces of information on the client terminal 4) can be adopted. When the packet transfer systems 4 and 5 receive an ARP ACK signal, they transfer the ARP ACK signal. The packet transfer system 3 is the system that has transmitted the ARP request. Even when the packet transfer system 3 receives the ARP ACK signal, it does not transfer the ARP ACK signal.

The packet transfer system with address monitoring 2 (2100) receives a control communication packet, whereby it acquires information on a port having packets, which are received via the port, filtered. For example, the packet transfer system with address monitoring 2 (2100) acquires an IP address and a MAC address from the control communication packet, and records the IP address and MAC address in association with the identifier of a port (port 1), via which the control communication packet is received, in the user management table 2024-1. Moreover, On is recorded as the filtering check flag in association with the port information in the user-management table 2024-1. Thus, packets bearing the MAC address (00:40:50:60:70:80) and IP address (192.168.1.1) are filtered (step 154).

In the present embodiment, since the packet transfer system with address monitoring 3 (2200) transmits an ARP request, an ARP ACK signal is transferred from the client terminal 4 (1300) to the packet transfer system with address monitoring 3 (2200). A control communication packet is therefore produced and transmitted so that information required for filtering will be transmitted to the packet transfer system with address monitoring 2 (2100). Owing to the control communication packet, the packet transfer system with address monitoring 2 (2100) can interrupt communication of packets, which bear the MAC address (00:40:50:60:70:80) and IP address (192.168.1.1) of the client terminal 4 (1300) whose IP address (192.168.1.1) is a duplicate, via the port (port 1) thereof.

Furthermore, the packet transfer system with address monitoring 2 (2100) broadcasts the received control communication packet (step 155). Even if a client terminal receives the control communication packet, no problem will occur. Consequently, if the client terminal 3 (1200) accommodated by the communication network 2 receives the control communication packet, it may discard the control communication packet (step 156).

The broadcast control communication packet is received by each of the packet transfer systems with address monitoring 4 (2300) and 5 (2400), and then transferred (steps 159 to 162). Each of the packet transfer systems 4 (2300) and 5 (2400) may perform the same processing as that of steps 154 and 155. Since an ARP ACK signal is received in order to perform address filtering, the control communication packet may be ignored. Moreover, the client terminal 4 (1300) may receive the control communication packet and discard it similarly to the action performed at the step 156 (step 163).

After the ARP ACK signal is transmitted, a DHCP ACK signal is read from the DHCP ACK packet memory 2027-1 included in the packet transfer system with address monitoring 3 (220) (step 164). The protocol handling unit 2020 transmits the DHCP ACK signal to the packet transfer system with address monitoring 2 (2100) so that an IP address (192.168.1.1) will be assigned to the client terminal 3 (1200) (step 165).

The packet transfer system with address monitoring 2 (2100) having received the DHCP ACK signal transfers a DHCP request to the protocol handling unit 2020 via the reception port 2010-3 and reception buffer 2021 included therein, and runs the DHCP management routine 2026-1 so as to record the protocol type of the packet (herein DHCP ACK) in the user management table 2024-1 (step 106). Moreover, the protocol handling unit 2020 transmits the DHCP ACK signal to the client terminal 3 (1200) via the transmission buffer 2022 and transmission port 2010-3 via which the packet transfer system with address monitoring 3 (2200) is connected (step 167).

The DHCP ACK signal is used to assign the IP address (192.168.1.1) to the client terminal 3. Consequently, the client terminal 3 (1200) can use the IP address (192.168.1.1) and can communicate data (step 168). The present embodiment adopts, similarly to the second embodiment, the method in which the packet transfer system itself broadcasts an ARP request. The present embodiment can be modified so that a client terminal will broadcast the ARP request in the same manner as it does in the first embodiment.

Moreover, the connections of the system in accordance with each of the embodiment are presented as an example. Any other topology may be adopted. Moreover, ports via which a terminal, a server, and other transfer system are connected may be any appropriate ports.

According to the present invention, there are provided a packet transfer system, a communication network, and a packet transfer method which do not discontinue (hereinafter interrupt) data transfer via each port, but which, if a client terminal to be accommodated has a static IP address, disables the client terminal from transferring data. According to the present invention, there is provided a technology for interrupting communication by filtering packets, which are addressed to a client terminal that illegally accesses a network, on the basis of an IP address while employing a simple configuration. According to the present invention, even if packet transfer systems are cascaded, information required for the filtering can be transmitted to each of the packet transfer systems.

1. A packet transfer system comprising:
a plurality of ports via which a first terminal and/or a second terminal and an address provision server are connected and packets are transmitted or received;
a memory unit in which each of the identifiers of the ports, a MAC address and an IP address that are contained in a response to an ARP request used to map an IP address into a MAC address, and a filtering check flag signifying whether filtering should be performed are stored in association with one another;
a processing unit that transfers a received packet and filters packets, wherein:
when the processing unit receives an address provision request from the first terminal connected via one of the ports, the processing unit transmits the address provision request to the address provision server;
the processing unit receives an address provision response which contains an IP address to be assigned to the first terminal and which is transmitted from the address provision server in response to the address provision request;
the processing unit broadcasts the ARP request, which contains the IP address to be assigned and is used to map an IP address to a MAC address, to terminals and systems connected via the ports;
when the processing unit receives the ARP response, which is returned from the second terminal or any other system that uses the IP address contained in the ARP request, via one of the ports, the processing unit records the MAC address and IP address of the second terminal or the system, which is contained in the ARP response, in association with the identifier of the port, via which the ARP response is received, in the memory unit, and sets the filtering check flag associated with the identifier of the port; and
the processing unit filters packets, which are addressed to the second terminal or the system, on the basis of the port in association with which the filter check flag is set in the memory unit and/or the MAC address and IP address associated with the flag.

2. The packet transfer system according to claim 1, wherein the processing unit receives the ARP request from the first terminal and broadcasts the ARP request according to the request, or the processing unit broadcasts the ARP request in response to the address provision response received from the address provision server.

3. The packet transfer system according to claim 1, wherein the processing unit transmits the received address provision response to the first terminal, receives the ARP request that is transmitted from the first terminal in response to the address provision response, and broadcasts the ARP request according to the request.

4. The packet transfer system according to claim 1, wherein:
the processing unit stores the received address provision response, and broadcasts the ARP request; and
after the processing unit receives the ARP response and sets the filtering check flag, or after the processing unit does not receive the ARP response within a predetermined period of time, the processing unit reaos the stored address provision response and transmits it to the first terminal.

5. The packet transfer system according to claim 1, wherein:
in the memory unit, the identifier of the port, and the MAC address of the first terminal and the IP address to be assigned to the first terminal, which are contained in the address provision request or address provision response, are stored;
the processing unit stores the MAC address of the first terminal and the IP address to be assigned to the first terminal, which are contained in the received address provision request or received address provision response, in association with the identifier of the port, via which the address provision request is received, in the memory unit; and
if the IP address contained in the address provision request or address provision response and stored in the memory unit agrees with the IP address contained in the ARP response, the filtering check flag associated with the identifier of the port via which the ARP response is received is set.

6. The packet transfer system according to claim 1, wherein:
when the processing unit receives the ARP response via one of the ports, the processing unit produces a control communication packet that contains the MAC address and IP address which are contained in the ARP response and based on which filtering is performed, and broadcasts the produced control communication packet;
when the control communication packet is transferred, information required for the filtering is transmitted to the other packet transfer systems accommodated by the communication network.

7. The packet transfer system according to claim 1, wherein when the processing unit receives a control communication packet, which contains a MAC address and an IP address based on which filtering is performed, via one of the ports, the processing unit stores the identifier of the port, via which the packet is received, and the MAC address and IP address, which are contained in the control communication packet, in the memory unit, and sets the filtering check flag associated with the identifier of the port.

8. A communication network comprising:
an address provision server that assigns an IP address in response to an address provision request;
a first packet transfer system comprising:
a plurality of ports via which a first terminal and/or a second terminal and an address provision server are connected and packets are transmitted or received;
a memory unit in which each of the identifiers of the ports, a MAC address and an IP address that are contained in a response to an ARP request used to map an IP address into a MAC address, and a filtering check flag signifying whether filtering should be performed are stored in association with one another;
a processing unit that transfers a received packet and filters packets, wherein:
when the processing unit receives an address provision request from the first terminal connected via one of the ports, the processing unit transmits the address provision request to the address provision server;
the processing unit receives an address provision response which contains an IP address to be assigned to the first terminal and which is transmitted from the address provision server in response to the address provision request;
the processing unit broadcasts the ARP request, which contains the IP address to be assigned and is used to map an IP address to a MAC address, to terminals and systems connected via the ports;
when the processing unit receives the ARP response, which is returned from the second terminal or any other system that uses the IP address contained in the ARP request, via one of the ports, the processing unit records the MAC address and IP address of the second terminal or the system, which is contained in the ARP response, in association with the identifier of the port, via which the ARP response is received, in the memory unit, and sets the filtering check flag associated with the identifier of the port;
the processing unit filters packets, which are addressed to the second terminal or the system, on the basis of the port in association with which the filter check flag is set in the memory unit and/or the MAC address and IP address associated with the flag;
the first packet transfer system is connected to a third terminal which uses an IP address assigned by the address provision server to communicate data; and
when the processing unit receives a control communication packet, which contains a MAC address and an IP address based on which filtering is performed, via one of the ports, the processing unit stores the identifier of the port, via which the packet is received, and the MAC address and IP address, which are contained in the control communication packet, in the memory unit, and sets the filtering check flag associated with the identifier of the port; and a second packet transfer system that is the packet transfer system comprising;
a plurality of ports via which a first terminal and/or a second terminal and an address provision server are connected and packets are transmitted or received;
a memory unit in which each of the identifiers of the ports, a MAC address and an IP address that are contained in a response to an ARP request used to map an IP address into a MAC address, and a filtering check flag signifying whether filtering should be performed are stored in association with one another;
a processing unit that transfers a received packet and filters packets, wherein;
when the processing unit receives an address provision request from the first terminal connected via one of the ports, the processing unit transmits the address provision request to the address provision server;
the processing unit receives an address provision response which contains an IP address to be assigned to the first terminal and which is transmitted from the address provision server in response to the address provision request;
the processing unit broadcasts the ARP request, which contains the IP address to be assigned and is used to map an IP address to a MAC address, to terminals and systems connected via the ports;
when the processing unit receives the ARP response, which is returned from the second terminal or any other system that uses the IP address contained in the ARP request, via one of the ports, the processing unit records the MAC address and IP address of the second terminal or the system, which is contained in the ARP response, in association with the identifier of the port, via which the ARP response is received, in the memory unit, and sets the filtering check flag associated with the identifier of the port;
the processing unit filters packets, which are addressed to the second terminal or the system, on the basis of the port in association with which the filter check flag is set in the memory unit and/or the MAC address and IP address associated with the flag;
when the processing unit receives the ARP response via one of the ports, the processing unit produces a control communication packet that contains the MAC address and IP address which are contained in the ARP response and based on which filtering is performed, and broadcasts the produced control communication packet;
when the control communication packet is transferred, information required for the filtering is transmitted to the other packet transfer systems accommodated by the communication network; and
the second packet transfer system is connected to each of the address provision server, the first packet transfer system, and a fourth terminal having a static IP address, and
when the second transfer system having received an ARP response from the fourth terminal transmits a control communication packet to the first packet transfer system, information required for filtering is transmitted to the first packet transfer system.

9. The communication network according to claim 8, further comprising one third transfer system or a plurality of third transfer systems that is realized with the first or second packet transfer system that is connected between the fourth terminal and the second transfer system, wherein:
when the third transfer system receives an ARP response from the fourth terminal, the third transfer system transfers the ARP response to the second transfer system.

10. A packet transfer method comprising the steps of:
when receiving an address provision request from a first terminal connected via one of the ports via which packets are transmitted or received, transmitting the address provision request to an address provision server;
receiving an address provision response that is transmitted from the address provision server in response to the address provision request and that contains an IP address to be assigned to the first terminal;
broadcasting an ARP request, which contains the IP address to be assigned, to terminals and systems connected via the ports;
when receiving an ARP response, which is transmitted from a second terminal or a system that uses the IP address contained in the ARP request, via one of the ports, recording the MAC address and IP address of the second terminal or the system, which are contained in the ARP response, in association with the identifier of the port, via which the ARP response is received, in a memory unit, and setting a filtering check flag associated with the identifier of the port; and
filtering packets, which are addressed to the second terminal or the system, on the basis of the port in association with which a filtering check flag is set in the memory unit and/or the MAC address and IP address associated with the flag.
